(19) United States
(12) Patent Application Publication
(10) Pub. No.: US 2025/0276514 A1
(43) Pub. Date: Sep. 4, 2025

(54) EJECTION ELEMENT SUBSTRATE AND LIQUID EJECTION HEAD

(71) Applicant: CANON KABUSHIKI KAISHA, Tokyo (JP)

(72) Inventors: YASUO FUJII, Kanagawa (JP); TOSHIO NEGISHI, Kanagawa (JP)

(21) Appl. No.: 19/068,593

(22) Filed: Mar. 3, 2025

(30) Foreign Application Priority Data
Mar. 4, 2024 (JP) 2024-032205

(51) Int. Cl. B41J 2/045; B41J 2/14

(52) U.S. Cl. CPC B41J 2/04541; B41J 2/04548; B41J 2/0458; B41J 2/14072; B41J 2/14145

(57) ABSTRACT

An object is to reduce the area of an ejection element substrate. To this end, the ejection element substrate includes multiple n-th (n=1, 2) energy generation elements, multiple n-th drive circuits configured to drive the respective n-th energy generation elements, and an n-th selection circuit configured to select some of the n-th drive circuits from the multiple n-th drive circuits and cause the selected n-th drive circuits to drive some of the n-th energy generation elements corresponding to the selected n-th drive circuits, respectively. The multiple n-th drive circuits are arranged in a first direction, multiple first energy generation elements and multiple second energy generation elements are arranged side by side in a region between a region where multiple first drive circuits are arranged and a region where multiple second drive circuits are arranged such that a first direction is a main direction.

### BACKGROUND

### Field

The present disclosure relates to an ejection element substrate and a liquid ejection head.

### Description of the Related Art

A liquid ejection head used in a liquid ejection apparatus such as an inkjet printer uses an ejection element substrate as one of components. Multiple liquid ejection ports for ejecting liquid are arranged side by side on a surface of an orifice plate attached to the ejection element substrate to penetrate the orifice plate. Each liquid ejection port communicates with a pressure chamber provided in a boundary region between the ejection element substrate and the orifice plate. The liquid in the pressure chamber is ejected from the liquid ejection port to a printing medium such as a sheet by being driven by an energy generation element. Japanese Patent Laid-Open No. 2012-254527 discloses an ejection element substrate in which liquid ejection ports are arranged in a staggered pattern of two arrays to increase the number of ink ejection ports in an array direction.

However, in the ejection element substrate disclosed in Japanese Patent Laid-Open No. 2012-254527, as illustrated in FIG. 1 thereof, multiple ink supply ports arranged side by side in two arrays and multiple through-holes arranged side by side in one array are arranged between the two arrays of the liquid ejection ports. Accordingly, a distance between the two arrays of the liquid ejection port is large. This increases the area of the ejection element substrate, and may become a hinderance in downsizing of the liquid ejection head.

### SUMMARY

The present disclosure has been made in view of the above-mentioned points, and an object is to reduce the area of an ejection element substrate.

In a first aspect of the present disclosure, there is provided An ejection element substrate comprising: a plurality of first energy generation elements; a plurality of first drive circuits configured to drive the plurality of first energy generation elements, respectively; a first selection circuit configured to select some of the first drive circuits from the plurality of first drive circuits and cause the selected first drive circuits to drive some of the first energy generation elements corresponding to the selected first drive circuits, respectively; a plurality of second energy generation elements; a plurality of second drive circuits configured to drive the plurality of second energy generation elements, respectively; and a second selection circuit configured to select some of the second drive circuits from the plurality of second drive circuits and cause the selected second drive circuits to drive some of the second energy generation elements corresponding to the selected second drive circuits, respectively, wherein the plurality of first drive circuits are arranged side by side in a first direction and the plurality of second drive circuits are arranged side by side along the first direction, and the plurality of first energy generation elements and the plurality of second energy generation elements are arranged side by side in a region between a region where the plurality of first drive circuits are arranged and a region where the plurality of second drive circuits are arranged such that a set of an integer number of the first energy generation elements and a set of the integer number of the second energy generation elements are arranged alternately with the first direction being a main direction, the integer number being one or more.

In a second aspect of the present disclosure, there is provided A liquid ejection head comprising: an ejection element substrate; and an orifice plate attached to the ejection element substrate, wherein the ejection element substrate includes: a plurality of first energy generation elements; a plurality of first drive circuits configured to drive the plurality of first energy generation elements, respectively; a first selection circuit configured to select some of the first drive circuits from the plurality of first drive circuits and cause the selected first drive circuits to drive some of the first energy generation elements corresponding to the selected the first drive circuits, respectively; a plurality of second energy generation elements; a plurality of second drive circuits configured to drive the plurality of second energy generation elements, respectively; and a second selection circuit configured to select some of the second drive circuits from the plurality of second drive circuits and cause the selected second drive circuits to drive some of the second energy generation elements corresponding to the selected second drive circuits, respectively, the plurality of first drive circuits are arranged side by side along a first direction, and the plurality of second drive circuits are arranged side by side along the first direction, the plurality of first energy generation elements and the plurality of second energy generation elements are arranged side by side in a region between a region where the plurality of first drive circuits are arranged and a region where the plurality of second drive circuits are arranged such that the first direction is a main direction, a boundary portion between the ejection element substrate and the orifice plate is provided with a first common flow path communicating with a plurality of first ink supply ports, a second common flow path communicating with a plurality of second ink supply ports, a plurality of first individual flow paths communicating with the first common flow path, a plurality of second individual flow paths communicating with the second common flow path, and a plurality of pressure chambers communicating with the plurality of first individual flow paths, respectively, and with the plurality of second individual flow paths, respectively, the orifice plate includes a plurality of ejection ports that allow the plurality of pressure chambers to communicate with an outside, and the energy generation elements are arranged at positions where the energy generation elements face the ejection ports of the pressure chambers, respectively.

Further features of the present disclosure will become apparent from the following description of exemplary embodiments with reference to the attached drawings.

### BRIEF DESCRIPTION OF THE DRAWINGS

FIG. 1 is a plan diagram illustrating an entire ejection element substrate according to first to third embodiments;

FIG. 2A is a partially-enlarged plan diagram illustrating part of the ejection element substrate according to the first to third embodiments;

FIG. 2B is a partially-enlarged plan diagram illustrating part of a liquid ejection head according to the first to third embodiments;

FIG. 2C is a cross-sectional diagram of the liquid ejection head according to the first to third embodiments;

FIG. 3 is a circuit diagram illustrating circuits mounted in the ejection element substrate according to the first embodiment;

FIG. 4 is a timing chart illustrating an operation of the circuits mounted in the ejection element substrate according to the first embodiment;

FIG. 5 illustrates a table illustrating a relationship between selection control data to be inputted into two selection circuits and heaters to be selected by these selection circuits in the ejection element substrate according to the first embodiment;

FIG. 6 is a circuit diagram illustrating circuits mounted in the ejection element substrate according to the second embodiment;

FIG. 7 is a timing chart illustrating an operation of the circuits mounted in the ejection element substrate according to the second embodiment;

FIG. 8 illustrates a table illustrating a relationship between selection control data to be inputted into two selection circuits and heaters to be selected by these selection circuits in the ejection element substrate according to the second embodiment;

FIG. 9 is a circuit diagram illustrating circuits mounted in the ejection element substrate according to the third embodiment;

FIG. 10 illustrates a timing chart illustrating an operation of the circuits mounted in the ejection element substrate according to the third embodiment;

FIG. 11 illustrates a table illustrating a relationship between selection control data to be inputted into two selection circuits and heaters to be selected by these selection circuits in the ejection element substrate according to the third embodiment;

FIG. 12 is a plan diagram illustrating an entire ejection element substrate according to fourth to sixth embodiments;

FIG. 13 is a partially-enlarged plan diagram illustrating part of the ejection element substrate according to the fourth to sixth embodiments;

FIG. 14 is a circuit diagram illustrating circuits mounted in the ejection element substrate according to the fourth embodiment;

FIG. 15 illustrates a table illustrating a relationship between selection control data to be inputted into two selection circuits and heaters to be selected by these selection circuits in the ejection element substrate according to the fourth embodiment;

FIG. 16 is a circuit diagram illustrating circuits mounted in the ejection element substrate according to the fifth embodiment;

FIG. 17 illustrates a table illustrating a relationship between selection control data to be inputted into two selection circuits and heaters to be selected by these selection circuits in the ejection element substrate according to the fifth embodiment;

FIG. 18 is a circuit diagram illustrating circuits mounted in the ejection element substrate according to the sixth embodiment;

FIG. 19 is a plan diagram illustrating an entire ejection element substrate according to other embodiments;

FIG. 20 is a partially-enlarged plan diagram illustrating part of the ejection element substrate according to the other embodiments; and

FIG. 21 is a partially-enlarged plan diagram illustrating part of the ejection element substrate according to the other embodiments.

### DESCRIPTION OF THE EMBODIMENTS

Embodiments are explained below in detail with reference to the attached drawings. Note that the following embodiments do not limit the disclosure according to the scope of claims. Although multiple characteristics are described in the embodiments, not all of the multiple characteristics are necessarily essential for the disclosure, and the multiple characteristics may be used in any combination. Moreover, in the attached drawings, the same or similar configurations are denoted by the same reference numerals, and overlapping explanation is omitted in some cases.

### First Embodiment

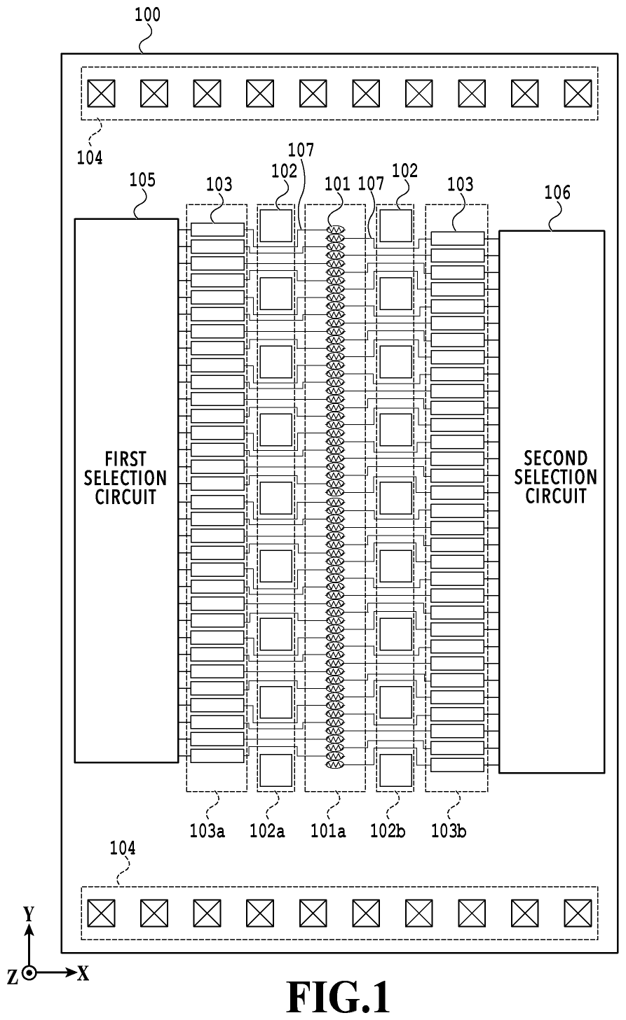

FIG. 1 is a plan diagram illustrating an entire ejection element substrate 100 according to a first embodiment. With reference to FIG. 1, a heater array 101a in which multiple heaters 101 are aligned in one array in a Y direction (also referred to as “first direction” or “main direction”) is arranged in a center portion of the ejection element substrate 100. A first ink supply port array 102a in which multiple ink supply ports 102 are aligned in one array in the Y direction, a first drive circuit array 103a in which multiple drive circuits 103 are aligned in one array in the Y direction, and a first selection circuit 105 are arranged on the left side of the heater array 101a in this order from the side closer to the heater array 101a. A second ink supply port array 102b in which multiple ink supply ports 102 are aligned in one array in the Y direction, a second drive circuit array 103b in which multiple drive circuits 103 are aligned in one array in the Y direction, and a second selection circuit 106 are arranged on the right side of the heater array 101a in this order from the side closer to the heater array 101a. A set of the first ink supply port array 102a, the first drive circuit array 103a, and the first selection circuit 105 is arranged on the opposite side of the heater array 101a to the side on which a set of the second ink supply port array 102b, the second drive circuit array 103b, and the second selection circuit 106 are arranged. Moreover, the set of the first ink supply port array 102a, the first drive circuit array 103a, and the first selection circuit 105 is arranged to be line symmetric to the set of the second ink supply port array 102b, the second drive circuit array 103b, and the second selection circuit 106, with respect to the heater array 101a. Note that a terminal array 104 in which multiple terminals are aligned is arranged near each of an upper edge and a lower edge of the ejection element substrate 100.

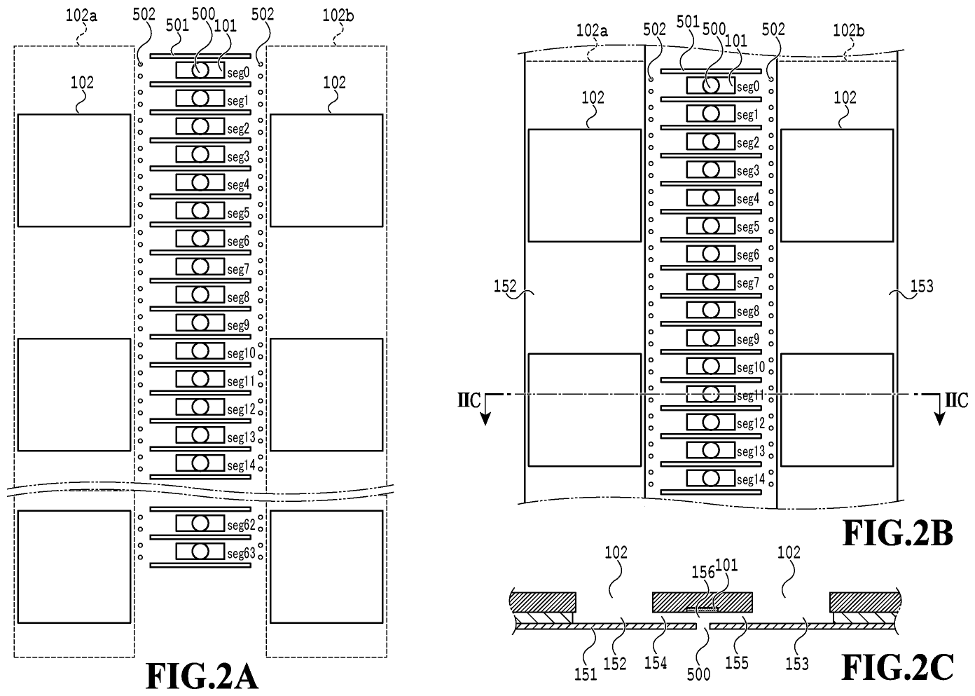

In the heater array 101a, the multiple heaters 101 are arranged at a pitch of 1,200 dpi. The heaters 101 are one type of energy generation elements that generate energy and provide the energy to ink being liquid to eject the ink from pressure chambers 156 (see FIG. 2C) to the outside via ejection ports 500 (see FIGS. 2A and 2C). The heaters 101 are arranged at positions where the heaters 101 face the ejection ports 500 across the pressure chambers 156. Accordingly, as illustrated in FIG. 2A, the ejection ports 500 and the heaters 101 are arranged to overlap one another in a plane direction (XY direction) of the ejection element substrate 100. Moreover, the ejection ports 500 and the heaters 101 are arranged near the centers of the pressure chambers 156. The energy generation elements are not limited to the heaters, and for example, piezoelectric elements may be used as the energy generation elements.

Explanation is given below with the respective heaters 101 named as Seg0, Seg1, . . . , Seg62, and Seg63 from the top as illustrated in FIG. 2A.

The ink supply ports 102 penetrate the ejection element substrate 100 in a thickness direction (Z direction). Common flow paths 152 and 153 (see FIGS. 2B and 2C) communicating with the multiple ink supply ports 102 aligned in the Y direction are formed in the Y direction in a boundary region between the ejection element substrate 100 and an orifice plate 151 (see FIG. 2C). Moreover, the pressure chambers 156 are also formed in the boundary region, and individual flow paths 154 and 155 (see FIG. 2C) that allow the individual pressure chambers 156 and the common flow paths 152 and 153 to communicate with one another are also formed in the boundary region. For example, the multiple ink supply ports 102 aligned in the ink supply port array 102a, the common flow path 152 communicating with the multiple ink supply ports 102, and the individual flow paths 154 communicating with the common flow path 152 are used to supply the ink to the pressure chambers 156. Moreover, the multiple ink supply ports 102 aligned in the ink supply port array 102b, the common flow path 153 communicating with the multiple ink supply ports 102, and the individual flow paths 155 communicating with the common flow path 153 are used to supply the ink to the pressure chambers 156 or to collect the ink from the pressure chambers 156.

The heaters 101 are connected to the drive circuits 103 via wiring lines 107 arranged between each adjacent two of the ink supply ports 102. The multiple drive circuits 103 belonging to the first drive circuit array 103a are connected, respectively, to the heaters seg0, Seg2, . . . , and Seg 62 which are even-numbered heaters 101. The multiple drive circuits 103 belonging to the second drive circuit array 103b are connected, respectively, to the heaters seg1, Seg3, . . . , and Seg 63 which are odd-numbered heaters 101.

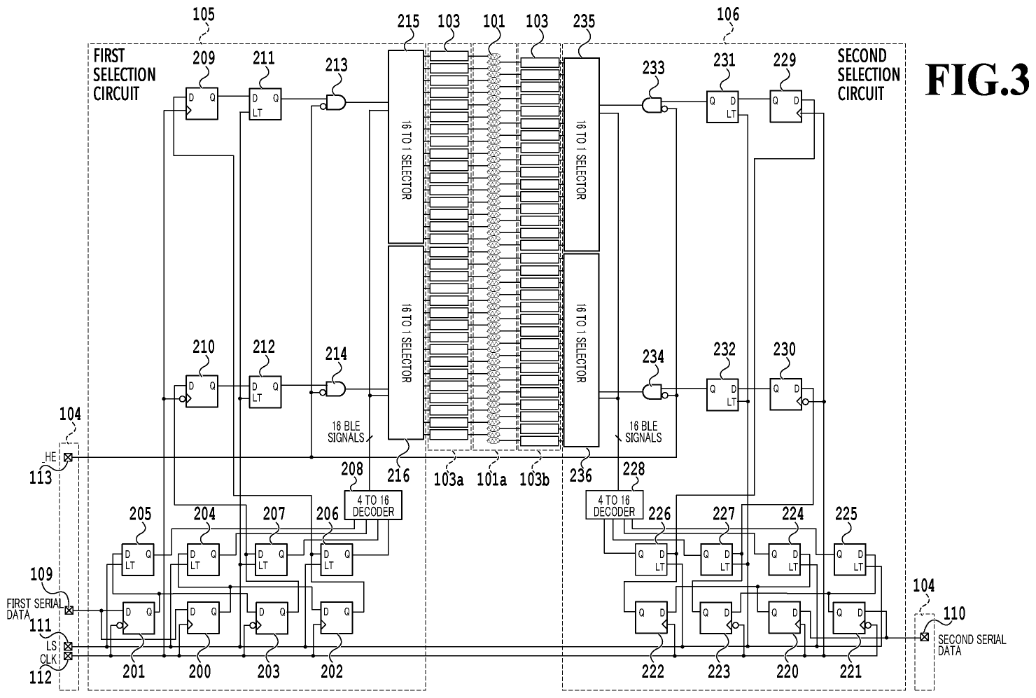

As described later, the first selection circuit 105 selects some of the heaters Seg0, Seg2, . . . , and Seg62 according to, for example, first selection control data obtained by parallelizing first serial data (see FIG. 3). Then, the first selection circuit 105 causes the drive circuits 103 corresponding to the selected heaters to drive the selected heaters. Accordingly, some of the heaters selected from among the heaters Seg0, Seg2, . . . , and Seg62 according to the first selection control data are driven, and the ink is ejected from the ejection ports 500 corresponding to the selected heaters according to this drive. Note that the first selection circuit 105 directly selects the drive circuits 103 corresponding to the selected heaters 101. Then, the selected drive circuits 103 drive the corresponding heaters 101 at an intensity depending on a not-illustrated signal. Note that, in the case where the description simply states that the drive circuits 103 drive the heaters 101 below, this means that the drive circuits 103 drive the heaters 101 at the intensity depending on the not-illustrated signal. However, the present disclosure is not limited to this, and the above-mentioned description may also mean that the drive circuits 103 drive the heaters 101 at a fixed intensity.

As described later, the second selection circuit 106 selects some of the heaters Seg1, Seg3, . . . , and Seg63 according to, for example, second selection control data obtained by parallelizing second serial data (see FIG. 3). Then, the second selection circuit 106 causes the drive circuits 103 corresponding to the selected heaters to drive the selected heaters. Accordingly, some of the heaters selected from among the heaters Seg1, Seg3, . . . , and Seg63 according to the second selection control data are driven, and the ink is ejected from the ejection ports 500 corresponding to the selected heaters according to this drive. Note that the second selection circuit 106 directly selects the drive circuits 103 corresponding to the selected heaters 101. Then, the selected drive circuits 103 drive the corresponding heaters 101.

In the following explanation, an expression “the selection circuit selects the heaters 101” also means that the selection circuit selects the drive circuits 103 corresponding to the selected heaters 101. Moreover, an expression “the selection circuit selects the drive circuits 103” also means that the selection circuit selects the heaters 101 corresponding to the selected drive circuits 103. The “selection circuit” herein is the selection circuit 105 or the selection circuit 106.

A power supply terminal, a ground terminal, a first serial data terminal 109 (see FIG. 3) for inputting the first serial data, a second serial data terminal 110 (see FIG. 3) for inputting the second serial data, and a clock terminal 112 (see FIG. 3) for inputting a clock (also referred to as “CLK”) are arranged side by side in the terminal arrays 104. Moreover, a latch signal terminal 111 (see FIG. 3) for inputting a latch signal (also referred to as “LS”) and a heater enable terminal 113 for inputting a heater enable signal (also referred to as “_HE”) are also arranged side by side in the terminal array 104. In this case, “_” included in “HE signal” indicates a negative logic.

FIG. 2A is a plan diagram in which part of the ejection element substrate 100 according to the first embodiment is enlarged. A surface of the ejection element substrate 100 is covered with the orifice plate 151 in which the ejection ports 500 are formed. As described above, the pressure chambers 156, the individual flow paths 154 and 155, and the common flow paths 152 and 153 are also formed in the boundary portion between the ejection element substrate 100 and the orifice plate 151. In FIG. 2A, the orifice plate 151 is illustrated in a transparent manner to illustrate the positions of the respective elements in the ejection element substrate 100. The ejection ports 500 are ports that allow the pressure chambers 156 and the outside to communicate with one another as described above, and penetrate the orifice plate 151.

Although this explanation overlaps the explanation made with reference to FIG. 1, as illustrated in FIG. 2A, the first ink supply port array 102a and the second ink supply port array 102b are arranged to be left-right symmetric across the heater array 101a. In this case, the heaters 101 are aligned in the heater array 101a, and the ejection ports 500 are also similarly aligned. Moreover, the multiple ink supply ports 102 are aligned in the first ink supply port array 102a, and the multiple ink supply ports are also aligned in the second ink supply port array 102b. Furthermore, the two common flow paths 152 and 153 are arranged at line symmetric positions with respect to the heater array 101a. Moreover, the individual flow paths 154 that allow the one common flow path 152 to communicate with the pressure chambers 156 and the individual flow paths 155 that allow the other common flow path 153 to communicate with the pressure chambers 156 are arranged at line symmetric positions with respect to the heater array 101a. The one individual flow path 154 communicating with each pressure chamber 156 allows the pressure chamber 156 to communicate with the common flow path 152 communicating with the multiple ink supply ports 102 in the ink supply port array 102a. The other individual flow path 155 communicating with each pressure chamber 156 allows the pressure chamber 156 to communicate with the common flow path 153 communicating with the multiple ink supply ports 102 in the ink supply port array 102b. Accordingly, a liquid resistance from the common flow path 152 corresponding to the ink supply port array 102a to the pressure chambers 156 and a liquid resistance from the common flow path 153 corresponding to the ink supply port array 102b to the pressure chambers 156 are substantially the same.

As illustrated in FIG. 2A, a partition 501 is formed between each adjacent two of the heaters 101 in the plane direction (XY direction) of the ejection element substrate 100. The partition 501 is formed integrally with the orifice plate 151, and is bonded to the surface of the ejection element substrate 100.

Moreover, an array of columnar filters 502 is arranged between the first ink supply port array 102a and an array of the heaters 101 and the partitions 501. Similarly, an array of columnar filters 502 is arranged also between the second ink supply port array 102b and the array of heaters 101 and the partitions 501. Each of the filters 502 is formed integrally with the orifice plate 151, and is bonded to the surface of the ejection element substrate 100. Note that, in the example of FIGS. 2A to 2C, each pressure chamber 156 is surrounded on six sides by the orifice plate 151, the heater 101, two partitions 501, and two pairs of filters 502.

FIG. 3 is a circuit diagram illustrating circuits mounted in the ejection element substrate 100 according to the first embodiment. FIG. 3 particularly illustrates details of the first selection circuit 105 and the second selection circuit 106.

The terminal arrays 104 include the clock terminal 112, the first serial data terminal 109, and the second serial data terminal 110. Moreover, the terminal arrays 104 further include the latch signal terminal 111 and the heater enable terminal 113.

The clock CLK, the latch signal LS, and the heater enable signal_HE are supplied to both of the first selection circuit 105 and the second selection circuit 106. However, the first serial data is supplied only to the first selection circuit 105, and the second serial data is supplied only to the second selection circuit 106.

The first selection circuit 105 includes D-type flip-flops (hereinafter, referred to as “DFF”) 200 to 203, 209, and 210 and latches (hereinafter, referred to as “LT”) 204 to 207, 211, and 212. Moreover, the first selection circuit 105 also includes a decoder 208, logical product operation circuits (hereinafter, referred to as “AND”) 213 and 214, and selectors 215 and 216. The DFFs 200 to 203, 209, and 210 and the LTs 204 to 207, 211, and 212 form a conversion circuit configured to convert the first serial data to parallel data.

The second selection circuit 106 includes DFFs 220 to 223, 229, and 230, LTs 224 to 227, 231, and 232, a decoder 228, ANDs 233 and 234, and selectors 235 and 236. The DFFs 220 to 223, 229, and 230 and the LTs 224 to 227, 231, and 232 form a conversion circuit configured to convert the second serial data to parallel data.

The decoder 208 expands the first selection control data encoded in 4-bit binary to 16 BLE signals. The decoder 228 also similarly expands the second selection control data encoded in 4-bit binary to other 16 BLE signals. The BLE signals are signals that individually designate the heater 101 to be selected by the enabled selectors 215, 216, 235, or 236. Accordingly, each of the selectors 215, 216, 235, and 236 selects and activates the drive circuit 103 for diving the heater 101 corresponding to the BLE signal that is at a HIGH level in the case where the selector is enabled. The selected and activated drive circuit 103 drive the corresponding heater 101. Note that only one BLE signal is set to the HIGH level among the 16 BLE signals inputted into one selector. The same applies to the embodiments described later.

In the explanation of the present embodiment, an expression “the selector selects the heater 101” also means that the selector selects the drive circuit 103 corresponding to the selected heater 101. Moreover, an expression “the selector selects the drive circuit 103” also means that the selector selects the heater 101 selected by the selected drive circuit 103. The “selector” herein is any of the selectors 215, 216, 235, and 236. The same applies to the embodiments described later.

The first serial data is taken into the DFF 200 in synchronization with a rising edge of the CLK. Thereafter, the first serial data taken into the DFF 200 is transferred to the DFF 202 and the DFF 209 in sequence in synchronization with the rising edge of the CLK. Moreover, the first serial data is taken into the DFF 201 in synchronization with a falling edge of the CLK. Thereafter, the first serial data taken into the DFF 201 is transferred to the DFF 203 and the DFF 210 in sequence in synchronization with the falling edge of the CLK.

The LTs 204 to 207, 211, and 212 latch Q outputs of the DFFs 200 to 203, 209, and 210, respectively, at a rising edge of the LS.

Q outputs of the LTs 204 to 207 are supplied to the decoder 208 as the selection control data encoded in binary. The decoder 208 sets one BLE signal designated by the Q outputs of the LTs 204 to 207 among the 16 BLE signals, to HIGH.

In the case where the _HE goes to Low, outputs of the ANDs 213 and 214 go to High in response to High Q outputs of the LTs 211 and 212. In the case where the output of the AND 213 is High, the selector 215 selects one of 16 drive circuits 103 depending on the output of the decoder 208. One of the 16 heaters Seg0, Seg2, . . . , Seg28, and Seg30 is thereby driven by the selected drive circuit 103. Similarly, in the case where the output of the AND 214 is High, the selector 216 selects one of 16 drive circuits 103 depending on the output of the decoder 208. One of the 16 heaters Seg32, Seg34, Seg60, and Seg62 is thereby driven by the selected drive circuit 103.

The second serial data is taken into the DFF 220 in synchronization with the rising edge of the CLK. Thereafter, the second serial data taken into the DFF 220 is transferred to the DFF 222 and the DFF 229 in sequence in synchronization with the rising edge of the CLK. Moreover, the second serial data is taken into the DFF 221 in synchronization with the falling edge of the CLK. Thereafter, the second serial data taken into the DFF 221 is transferred to the DFF 223 and the DFF 230 in sequence in synchronization with the falling edge of the CLK.

The LTs 224 to 227, 231, and 232 latch Q outputs of the DFFs 220 to 223, 229, and 230 at the rising edge of the LS.

The Q outputs of the LTs 224 to 227 are supplied to the decoder 228 as the selection control data encoded in binary. The decoder 228 sets one BLE signal designated by the Q outputs of the LTs 224 to 227 among the 16 BLE signals to HIGH.

In the case where the _HE goes to Low, outputs of the ANDs 233 and 234 go to High in response to High Q outputs of the LTs 231 and 232. In the case where the output of the AND 233 is High, the selector 235 selects one of 16 drive circuits 103 depending on the output of the decoder 228. One of the 16 heaters Seg1, Seg3, . . . , Seg29, and Seg31 is thereby driven by the selected drive circuit 103. Similarly, in the case where the output of the AND 234 is High, the selector 236 selects one of 16 drive circuits 103 depending on the output of the decoder 228. One of the 16 heaters Seg33, Seg35, . . . , Seg61, and Seg63 is thereby driven by the selected drive circuit 103.

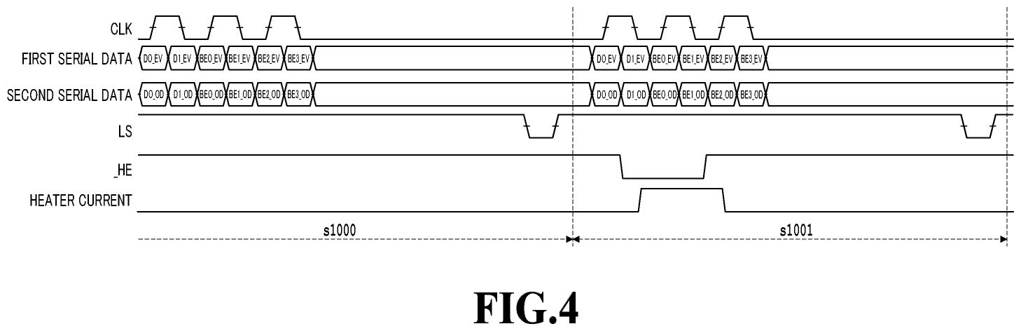

FIG. 4 is a timing chart illustrating an operation of the circuits mounted in the ejection element substrate 100 according to the first embodiment.

The first serial data includes D0_EV, D1_EV, BE0_EV, BE1_EV, BE2_EV, and BE3 EV. The D0 EV, the BE0_EV, and the BE2_EV correspond to the rising edge of the CLK. The D1 EV, the BE1_EV, and the BE3_EV correspond to the falling edge of the CLK.

Moreover, the second serial data includes D0_OD, D1_OD, BE0_OD, BE1_OD, BE2_OD, and BE3_OD. The D0_OD, the BE0_OD, and the BE2_OD correspond to the rising edge of the CLK. The D1_OD, the BE1_OD, and the BE3_OD correspond to the falling edge of the CLK.

In a period s1000, the first serial data and the second serial data for selecting the heaters 101 to be driven in a period s1001 are inputted in synchronization with the CLK, and are latched at the rising of the LS. In the case where the _HE goes to Low in the period s1001, the drive circuits 103 corresponding to the selected heaters are activated, and a heater current thereby flows in the selected heaters.

Similarly, in the period s1001, the first serial data and the second serial data for selecting the heaters 101 to be driven in a period subsequent to the period s1001 are inputted in synchronization with the CLK, and are latched at the rising of the LS. In the case where the _HE goes to Low in the period subsequent to the period S1001, the heater current flows in the selected heaters. This operation is repeated from this point on.

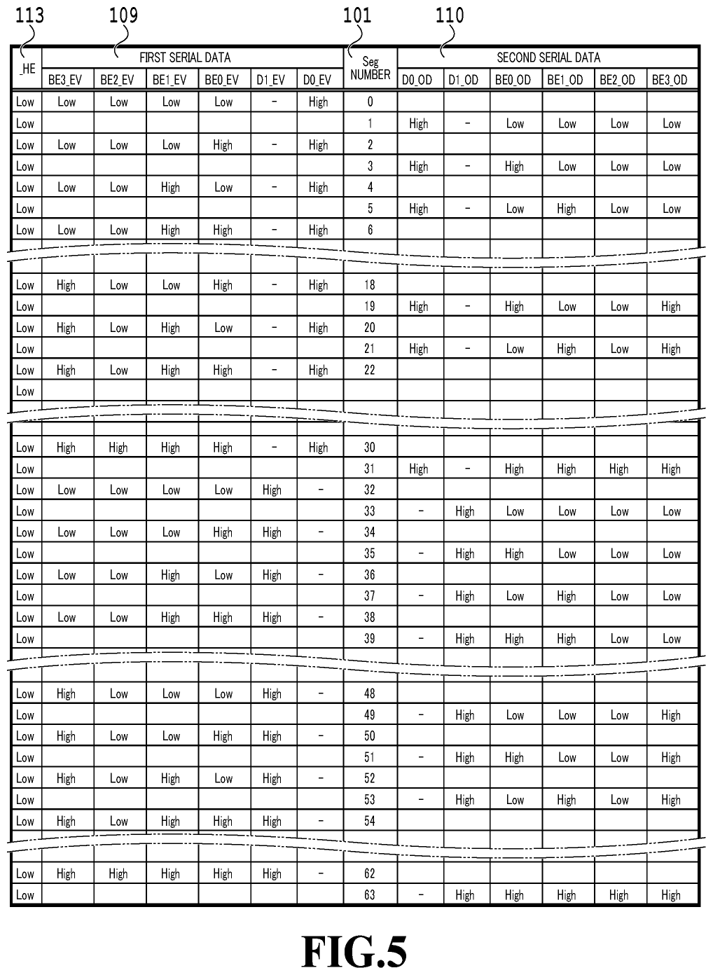

FIG. 5 illustrates a table illustrating a relationship between the selection control data inputted into the selection circuits 105 and 106 illustrated in FIG. 3 and the heaters 101 selected by these selection circuits 105 and 106. In this case, the selection control data is included in both of the first serial data and the second serial data. The BE0 EV, the BE1_EV, the BE2_EV, and the BE3_EV included in the first serial data form the first selection control data encoded in binary. The D0_EV, and the D1_EV included in the first serial data are the pieces of enable data for enabling the selectors 215 and 216, respectively. The BE0_OD, the BE1_OD, the BE2_OD, and the BE3_OD included in the second serial data form the second selection control data encoded in binary. The D0_OD and the D1_OD included in the second serial data are the pieces of enable data for enabling the selectors 235 and 236, respectively.

For example, in the case where only one heater Seg20 is to be selected, the values illustrated in FIG. 5 are set in the first serial data and the second serial data. Specifically, the pieces of data included in the first serial data are set as follows.
D0_EV: High
D1 EV: Low
BE0 EV: Low
BE1_EV: High
BE2 EV: Low
BE3_EV: High

Moreover, the pieces of data included in the second serial data are set as follows.
D0_OD: Low
D1_OD: Low
BE0 to 3_OD: High or Low

Then, in the case where the _HE goes to Low after the rising of the LS, one drive circuit 103 corresponding to the heater Seg20 is activated, and the heater Seg20 is driven.

Moreover, for example, in the case where only two heaters Seg20 and Seg 52 are to be selected, the values illustrated in FIG. 5 are set in the first serial data and the second serial data. Specifically, the pieces of data included in the first serial data are set as follows.
D0_EV: High
D1_EV: High
BE0 EV: Low
BE1_EV: High
BE2_EV: Low
BE3_EV: High

Moreover, the pieces of data included in the second serial data are set as follows.
D0_OD: Low
D1_OD: Low
BE0 to 3_OD: High or Low

Then, in the case where the HE goes to Low after the rising of the LS, total of two drive circuits 103 corresponding to the heaters Seg20 and Seg 52 are activated, and the heaters Seg20 and Seg 52 are driven.

Moreover, for example, in the case where four heaters Seg5, Seg20, Seg37, and Seg 52 are to be selected, the values illustrated in FIG. 5 are set in the first serial data and the second serial data. Specifically, the pieces of data included in the first serial data are set as follows.
D0_EV: High
D1_EV: High
BE0 EV: Low
BE1_EV: High
BE2 EV: Low
BE3_EV: High

Moreover, the pieces of data included in the second serial data are set as follows.
D0_OD: High
D1_OD: High
BE0 OD: Low
BE1_OD: High
BE2 OD: Low
BE3 OD: Low

Then, in the case where the _HE goes to Low after the rising of the LS, total of four drive circuits 103 corresponding to the heaters Seg5, Seg20, Seg37, and Seg 52 are activated, and the heaters Seg5, Seg20, Seg37, and Seg 52 are driven.

Zero to four drive circuits 103 can be activated depending on the number of pieces of data set to High among the D0_EV, the D1_EV, the D0_OD, and the D1_OD, and zero to four heaters can be driven in response to this activation.

In this case, the selectors 215, 216, 235, and 236 are enabled in the case where the D0_EV, the D1_EV, the D0_OD, and the D1_OD go to High, respectively. Then, in the case where the selectors 215 and 216 are enabled, the selectors 215 and 216 each select one heater 101 designated by the BE0_EV, the BE1_EV, the BE2_EV, and the BE3_EV, and cause the drive circuit 103 corresponding to the selected heater to drive the heater. Similarly, in the case where the selectors 235 and 236 are enabled, the selectors 235 and 236 each select one heater 101 designated by the BE0_OD, the BE1_OD, the BE2_OD, and the BE3_OD, and cause the drive circuit 103 corresponding to the selected heater to drive the heater. Accordingly, in the case where the circuit illustrated in FIG. 3 is viewed as a whole, a maximum of four heaters 101 are simultaneously driven by the drive circuits 103 corresponding to the respective heaters 101. In a view limited to the first selection circuit 105, a maximum of two heaters 101 are simultaneously driven by the drive circuits 103 corresponding to the respective heaters 101. Similarly, in a view limited to the second selection circuit 106, a maximum of two heaters 101 are simultaneously driven by the drive circuits 103 corresponding to the respective heaters 101. Accordingly, the first selection circuit 105 includes as many selectors as the maximum total number of heaters 101 simultaneously selectable by the first selection circuit 105. Similarly, the second selection circuit 106 includes as many selectors as the maximum total number of heaters 101 simultaneously selectable by the second selection circuit 106.

Since the heaters arranged in one array at high density can be driven as described above, the ejection element substrate 100 downsized, and the liquid ejection head including the ejection element substrate 100 can be also downsized.

### Second Embodiment

An ejection element substrate 100 according to a second embodiment has a basic configuration as illustrated in FIG. 1, like the ejection element substrate 100 according to the first embodiment.

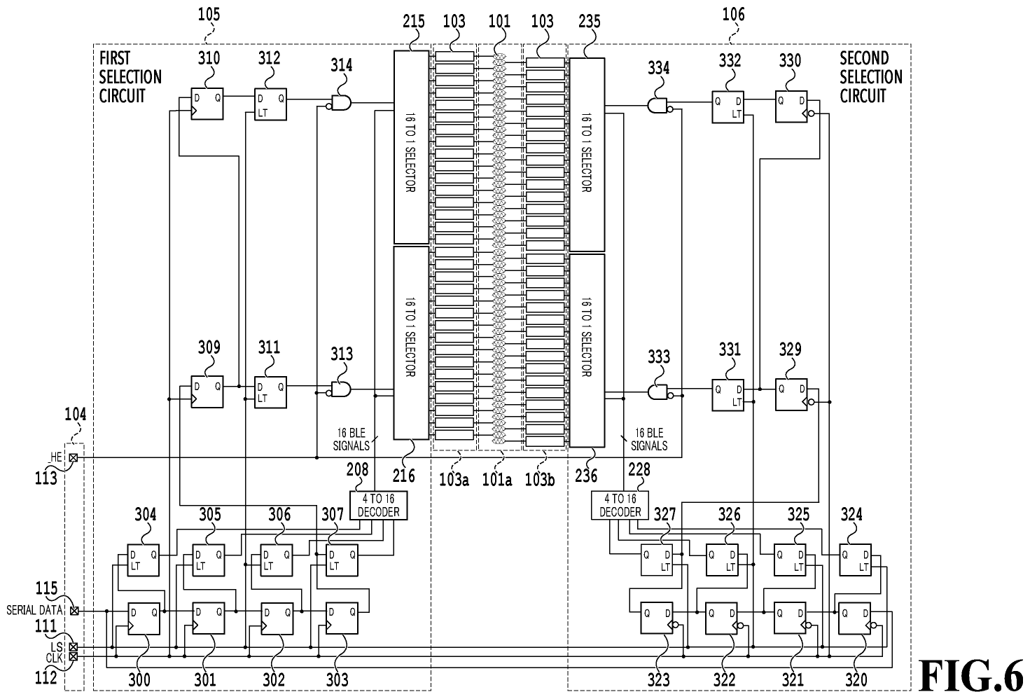

FIG. 6 is a circuit diagram illustrating circuits mounted in the ejection element substrate 100 according to the second embodiment. FIG. 6 particularly illustrates details of the first selection circuit 105 and the second selection circuit 106.

The terminal array 104 includes the clock terminal 112, a serial data terminal 115 for inputting serial data, the latch signal terminal 111, and the heater enable terminal 113.

The clock CLK, the latch signal LS, and the heater enable signal_HE are supplied to both of the first selection circuit 105 and the second selection circuit 106. The serial data is also supplied to both of the first selection circuit 105 and the second selection circuit 106.

The first selection circuit 105 includes DFFs 300 to 303, 309, and 310, LTs 304 to 307, 311, and 312, the decoder 208, ANDs 313 and 314, and the selectors 215 and 216. The second selection circuit 106 includes DFFs 320 to 323, 329, and 330, LTs 324 to 327, 331, and 332, the decoder 228, ANDs 333 and 334, and the selectors 235 and 236. The DFFs 300 to 303, 309, and 310 and the LTs 304 to 307, 311, and 312 form a conversion circuit configured to convert a part of the serial data to parallel data. The DFFs 320 to 323, 329, and 330 and the LTs 324 to 327, 331, and 332 form a conversion circuit configured to convert another part of the serial data to parallel data.

The serial data is taken into the DFF 300 in synchronization with the rising edge of the CLK. Thereafter, the serial data taken into the DFF 300 is transferred to the DFF 301, the DFF 302, the DFF 303, the DFF 309, and the DFF 310 in sequence in synchronization with the rising edge of the CLK.

Moreover, the serial data is taken into the DFF 320 in synchronization with the falling edge of the CLK. Thereafter, the serial data taken into the DFF 320 is transferred to the DFF 321, the DFF 322, the DFF 323, the DFF 329, and the DFF 330 in sequence in synchronization with the falling edge of the CLK.

The LTs 304 to 307, 311, 312, 324 to 327, 331, and 332 latch Q outputs of the DFFs 300 to 303, 309, 310, 320 to 323, 329, and 330, respectively, at the rising edge of the LS.

Q outputs of the LTs 304 to 307 are supplied to the decoder 208 as selection signals encoded in binary. The decoder 208 sets one BLE signal designated by the Q outputs of the LTs 304 to 307 among 16 BLE signals, to HIGH.

Similarly, Q outputs of the LTs 324 to 327 are supplied to the decoder 228 as selection signals encoded in binary. The decoder 228 sets one BLE signal designated by the Q outputs of the LTs 324 to 327 among 16 BLE signals, to HIGH.

In the case where the _HE goes to Low, outputs of the ANDs 313 and 314 go to High in response to High Q outputs of the LTs 311 and 312. In the case where the output of the AND 314 is High, the selector 215 selects one of 16 drive circuits 103 depending on the output of the decoder 208. One of the 16 heaters Seg0, Seg2, . . . , Seg28, and Seg30 is thereby driven by the selected drive circuit 103. Similarly, in the case where the output of the AND 313 is High, the selector 216 selects one of 16 drive circuits 103 depending on the output of the decoder 208. One of the 16 heaters Seg32, Seg34, . . . Seg60, and Seg62 is thereby driven by the selected drive circuit 103.

Moreover, in the case where the _HE goes to Low, outputs of the ANDs 333 and 334 go to High in response to High Q outputs of the LTs 331 and 332. In the case where the output of the AND 334 is High, the selector 235 selects one of 16 drive circuits 103 depending on the output of the decoder 228. One of the 16 heaters Seg1, Seg3, . . . , Seg29, and Seg31 is thereby driven by the selected drive circuit 103. Similarly, in the case where the output of the AND 333 is High, the selector 236 selects one of 16 drive circuits 103 depending on the output of the decoder 228. One of the 16 heaters Seg33, Seg35, . . . , Seg61, and Seg63 is thereby driven by the selected drive circuit 103.

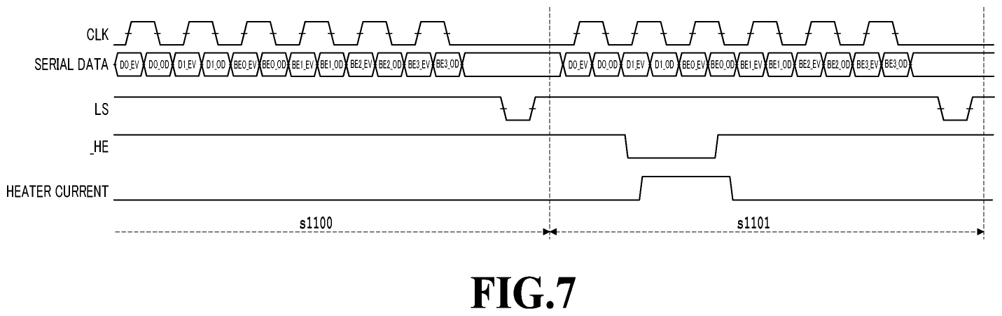

FIG. 7 is a timing chart illustrating an operation of the circuits mounted in the ejection element substrate 100 according to the second embodiment.

The serial data includes the D0_EV, the D0_OD, the D1_EV, the D1_OD, the BE0_EV, the BE0_OD, the BE1_EV, the BE1_OD, the BE2_EV, the BE2_OD, the BE3_EV, and the BE3_OD. The D0_EV, the D1_EV, the BE0_EV, the BE1 EV, the BE2_EV, and the BE3_EV correspond to the rising edge of the CLK. The D0_OD, the D1_OD, the BE0_OD, the BE1_OD, the BE2_OD, and the BE3_OD correspond to the falling edge of the CLK.

In a period s1100, the serial data for selecting the heaters 101 to be driven in a period s1101 is inputted in synchronization with the CLK, and is latched at the rising of the LS. In the case where the HE goes to Low in the period s1101, the heater current flows in the selected heaters.

Similarly, in the period s1101, the serial data for selecting the heaters 101 to be driven in a period subsequent to the period s1101 is inputted in synchronization with the CLK, and is latched at the rising of the LS. In the case where the _HE goes to Low in the period subsequent to the period S1101, the heater current flows in the selected heaters. This operation is repeated from this point on.

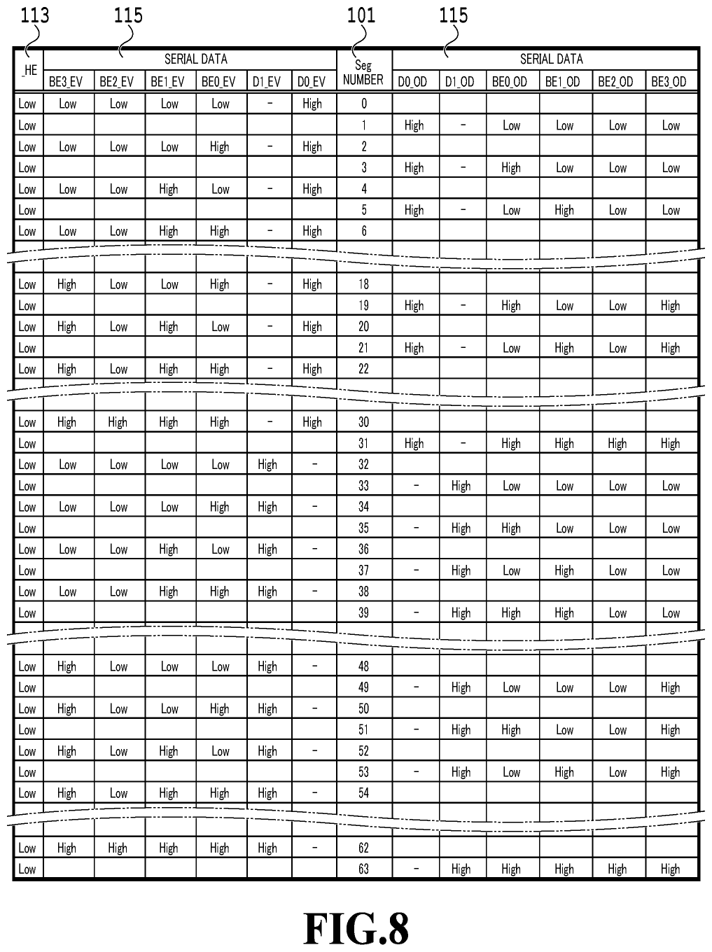

FIG. 8 illustrates a table illustrating a relationship between the selection control data inputted into the selection circuits 105 and 106 illustrated in FIG. 6 and the heaters 101 selected by these selection circuits 105 and 106. In this case, the selection control data is included in the serial data. The BE0 EV, the BE1_EV, the BE2_EV, and the BE3 EV included in the serial data form the first selection control data encoded in binary. The D0 EV and the D1 EV included in the serial data are the pieces of enable data for enabling the selectors 215 and 216, respectively. The BE0_OD, the BE1_OD, the BE2_OD, and the BE3_OD included in the serial data form the second selection control data encoded in binary. The D0_OD and the D1_OD included in the serial data are the pieces of enable data for enabling the selectors 235 and 236, respectively.

For example, in the case where only one heater Seg20 is to be selected, the values illustrated in FIG. 8 are set in the serial data. Specifically, the pieces of data included in the serial data are set as follows.
D0_EV: High
D1 EV: Low
BE0 EV: Low
BE1_EV: High
BE2 EV: Low
BE3_EV: High

Moreover, the other pieces of data included in the serial data are set as follows.
D0 OD: Low
D1_OD: Low
BE0 to 3_OD: High or Low

Then, in the case where the _HE goes to Low after the rising of the LS, one drive circuit 103 corresponding to the heater Seg20 is activated, and the heater Seg20 is driven.

Moreover, for example, in the case where only two heaters Seg20 and Seg 52 are to be selected, the values illustrated in FIG. 8 are set in the serial data. Specifically, the pieces of data included in the serial data are set as follows.
D0_EV: High
D1_EV: High
BE0_EV: Low
BE1_EV: High
BE2 EV: Low
BE3_EV: High

Moreover, the other pieces of data included in the serial data are set as follows.
D0_OD: Low
D1_OD: Low
BE0 to 3_OD: High or Low

Then, in the case where the _HE goes to Low after the rising of the LS, total of two drive circuits 103 corresponding to the heaters Seg20 and Seg 52 are activated, and the heaters Seg20 and Seg 52 are driven.

Moreover, for example, in the case where four heaters Seg5, Seg20, Seg37, and Seg 52 are to be selected, the values illustrated in FIG. 8 are set in the serial data. Specifically, the pieces of data included in the serial data are set as follows.
D0_EV: High
D1_EV: High
BE0_EV: Low
BE1_EV: High
BE2 EV: Low
BE3_EV: High

Moreover, the other pieces of data included in the serial data are set as follows.
D0_OD: High
D1_OD: High
BE0 OD: Low
BE1_OD: High
BE2 OD: Low
BE3_OD: Low

Then, in the case where the _HE goes to Low after the rising of the LS, total of four drive circuits 103 corresponding to the heaters Seg5, Seg20, Seg37, and Seg 52 are activated, and the heaters Seg5, Seg20, Seg37, and Seg 52 are driven.

Zero to four drive circuits 103 can be activated depending on the number of pieces of data set to High among the D0_EV, the D1_EV, the D0_OD, and the D1_OD, and zero to four heaters can be driven in response to this activation.

In this case, the selectors 215, 216, 235, and 236 are enabled in the case where the D0_EV, the D1_EV, the D0_OD, and the D1_OD go to High, respectively. Then, in the case where the selectors 215 and 216 are enabled, the selectors 215 and 216 each select one heater 101 designated by the BE0_EV, the BE1_EV, the BE2_EV, and the BE3 EV, and cause the drive circuit 103 corresponding to the selected heater to drive the heater. Similarly, in the case where the selectors 235 and 236 are enabled, the selectors 235 and 236 each select one heater 101 designated by the BE0_OD, the BE1_OD, the BE2_OD, and the BE3_OD, and cause the drive circuit 103 corresponding to the selected heater to drive the heater. Accordingly, in the case where the circuit illustrated in FIG. 6 is viewed as a whole, a maximum of four heaters 101 are simultaneously driven by the drive circuits 103 corresponding to the respective heaters 101. In a view limited to the first selection circuit 105, a maximum of two heaters 101 are simultaneously driven by the drive circuits 103 corresponding to the respective heaters 101. Similarly, in a view limited to the second selection circuit 106, a maximum of two heaters 101 are simultaneously driven by the drive circuits 103 corresponding to the respective heaters 101. Accordingly, the first selection circuit 105 includes as many selectors as the maximum total number of heaters 101 simultaneously selectable by the first selection circuit 105. Similarly, the second selection circuit 106 includes as many selectors as the maximum total number of heaters 101 simultaneously selectable by the second selection circuit 106.

Since the heaters arranged in one array at high density can be driven as described above, the ejection element substrate 100 can be downsized, and the liquid ejection head including the ejection element substrate 100 can be also downsized. Moreover, since the number of electrodes for data input can be reduced, it is possible to reduce sealing regions for preventing invasion of the ink into the electrodes and improve reliability.

### Third Embodiment

An ejection element substrate 100 according to the third embodiment has a basic configuration as illustrated in FIG. 1, like the ejection element substrate 100 according to the first embodiment.

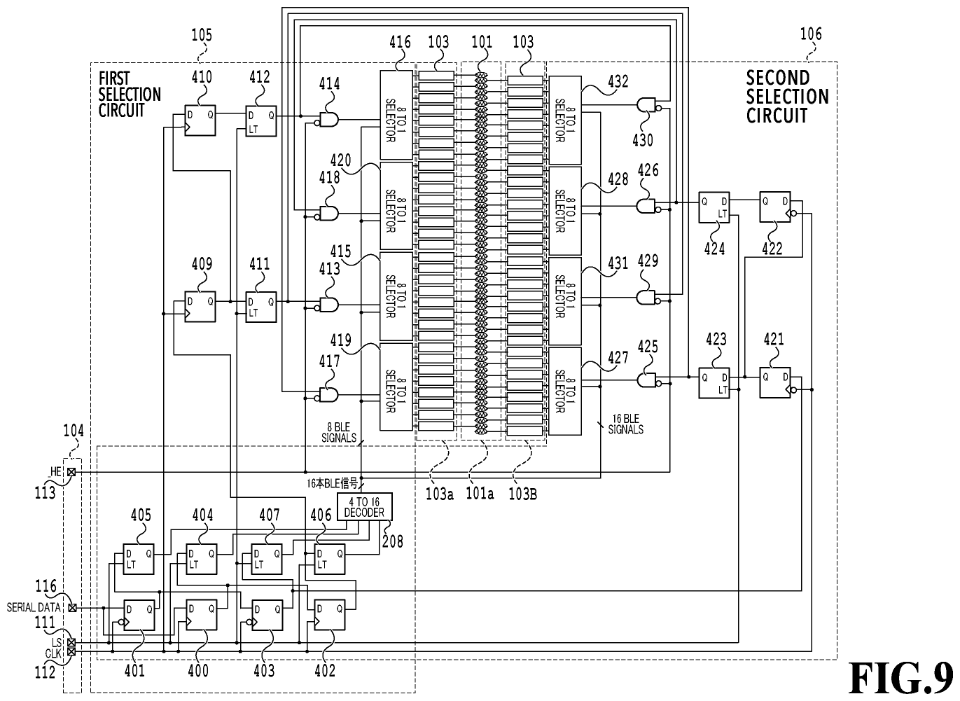

FIG. 9 is a circuit diagram illustrating circuits mounted in the ejection element substrate 100 according to the third embodiment. FIG. 6 particularly illustrates details of the first selection circuit 105 and the second selection circuit 106.

The terminal array 104 includes the clock terminal 112, a serial data terminal 116 for inputting serial data, the latch signal terminal 111, and the heater enable terminal 113.

The clock CLK, the latch signal LS, and the heater enable signal_HE are supplied to both of the first selection circuit 105 and the second selection circuit 106. The serial data is also supplied to both of the first selection circuit 105 and the second selection circuit 106.

The first selection circuit 105 includes DFFs 400 to 403, 409, and 410, LTs 404 to 407, 411, and 412, the decoder 208, ANDs 413, 414, 417, and 418, and selectors 415, 416, 419, and 420. The second selection circuit 106 includes DFFs 400 to 403, 421, and 422, LTs 404 to 407, 423, and 424, the decoder 208, ANDs 425, 426, 429, and 430, and selectors 427, 428, 431, and 432. Note that the DFFs 400 to 403, the LTs 404 to 407, and the decoder 208 are shared by the first selection circuit 105 and the second selection circuit 106. The DFFs 400 to 403, 409, 410, 421 and 422 and the LTs 404 to 407, 411, 412, 423, and 424 form a conversion circuit configured to convert the serial data to parallel data.

The serial data is taken into the DFF 400 in synchronization with the rising edge of the CLK. Thereafter, the serial data taken into the DFF 400 is transferred to the DFF 402, the DFF 409, and the DFF 410 in sequence in synchronization with the rising edge of the CLK.

Moreover, the serial data is taken into the DFF 401 in synchronization with the falling edge of the CLK. Thereafter, the serial data taken into the DFF 401 is transferred to the DFF 403, the DFF 421, and the DFF 422 in sequence in synchronization with the falling edge of the CLK.

The LTs 404 to 407, 411, 412, 423, and 424 latch Q outputs of the DFFs 400 to 403, 409, 410, 421, and 422, respectively, at the rising edge of the LS.

The Q outputs of the LTs 404 to 407 are supplied to the decoder 208 as the selection signals encoded in binary. The decoder 208 sets one BLE signal designated by the Q outputs of the LTs 404 to 407 among 16 BLE signals to HIGH.

In the case where the _HE goes to Low, outputs of the ANDs 413 and 429 goes to High in response to a High Q output of the LT 411. Moreover, in the case where the HE goes to Low, outputs of the ANDs 414 and 430 go to High in response to a High Q output of the LT 412. Furthermore, in the case where the _HE goes to Low, outputs of the ANDs 417 and 425 go to High in response to a High Q output of the LT 423. Moreover, in the case where the _HE goes to Low, outputs of the ANDs 418 and 426 go to High in response to a High Q output of the LT 424.

In this case, eight out of the 16 BLE signals outputted by the decoder 208 are supplied to the selectors 416, 420, 415, and 419, and the other eight BLE signals are supplied to the selectors 432, 428, 431, and 427.

In the case where the output of the AND 414 is High and one of the eight BLE signals supplied to the selector 416 is High, the selector 416 selects one of eight drive circuits 103 depending on the BLE selection signal that is High. One of the eight heaters Seg0, Seg2, . . . , Seg12, and Seg14 is thereby driven by the selected drive circuit 103.

In the case where the output of the AND 418 is High and one of the eight BLE signals supplied to the selector 420 is High, the selector 420 selects one of eight drive circuits 103 depending on the BLE selection signal that is High. One of the eight heaters Seg16, Seg18, . . . , Seg28, and Seg30 is thereby driven by the selected drive circuit 103.

In the case where the output of the AND 413 is High and one of the eight BLE signals supplied to the selector 415 is High, the selector 415 selects one of eight drive circuits 103 depending on the BLE selection signal that is High. One of the eight heaters Seg32, Seg34, . . . , Seg44, and Seg46 is thereby driven by the selected drive circuit 103.

In the case where the output of the AND 417 is High and one of the eight BLE signals supplied to the selector 419 is High, the selector 419 selects one of eight drive circuits 103 depending on the BLE selection signal that is High. One of the eight heaters Seg48, Seg50, . . . , Seg60, and Seg62 is thereby driven by the selected drive circuit 103.

In the case where the output of the AND 430 is High and one of the eight BLE signals supplied to the selector 432 is High, the selector 432 selects one of eight drive circuits 103 depending on the BLE selection signal that is High. One of the eight heaters Seg1, Seg3, . . . , Seg13, and Seg15 is thereby driven by the selected drive circuit 103.

In the case where the output of the AND 426 is High and one of the eight BLE signals supplied to the selector 428 is High, the selector 428 selects one of eight drive circuits 103 depending on the BLE selection signal that is High. One of the eight heaters Seg17, Seg19, . . . , Seg29, and Seg31 is thereby driven by the selected drive circuit 103.

In the case where the output of the AND 429 is High and one of the eight BLE signals supplied to the selector 431 is High, the selector 431 selects one of eight drive circuits 103 depending on the BLE selection signal that is High. One of the eight heaters Seg33, Seg35, . . . , Seg45, and Seg47 is thereby driven by the selected drive circuit 103.

In the case where the output of the AND 425 is High and one of the eight BLE signals supplied to the selector 427 is High, the selector 427 selects one of eight drive circuits 103 depending on the BLE selection signal that is High. One of the eight heaters Se49, Seg51, . . . , Seg61, and Seg63 is thereby driven by the selected drive circuit 103.

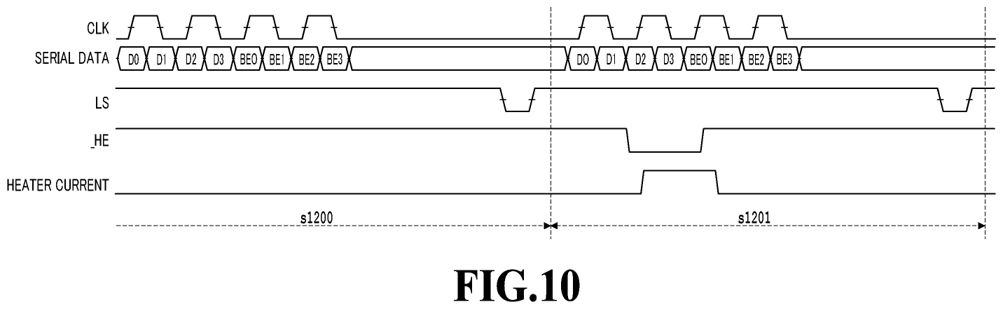

FIG. 10 is a timing chart illustrating an operation of the circuits mounted in the ejection element substrate 100 according to the third embodiment.

The serial data includes D0 to D3 and BE0 to BE3. The D0, the D2, the BE0, and the BE2 correspond to the rising edge of the CLK, and the D1, the D3, the BE1, and the BE3 correspond to the falling edge of the CLK.

In a period s1200, the serial data for selecting the heaters 101 to be driven in a period s1201 is inputted in synchronization with the CLK, and is latched at the rising of the LS. In the case where the HE goes to Low in the period s1201, the heater current flows in the selected heaters.

Similarly, in the period s1201, the serial data for selecting the heaters 101 to be driven in a period subsequent to the period s1201 is inputted in synchronization with the CLK, and is latched at the rising of the LS. In the case where the HE goes to Low in the period subsequent to the period S1201, the heater current flows in the selected heaters. This operation is repeated from this point on.

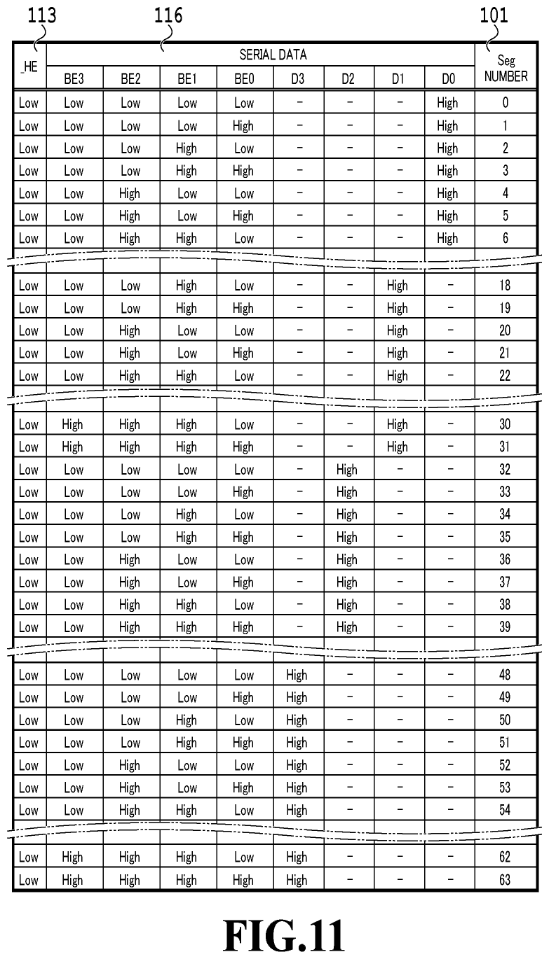

FIG. 11 illustrates a table illustrating a relationship between the selection control data inputted into the selection circuits 105 and 106 illustrated in FIG. 9 and the heaters 101 selected by these selection circuits 105 and 106. In this case, the selection control data is included in the serial data. The BE0, the BE1, the BE2, and the BE3 included in the serial data form the selection control data encoded in binary. The D0 included in the serial data is enable data for enabling the selectors 416 and 432. The D1 included in the serial data is enable data for enabling the selectors 420 and 428. The D2 included in the serial data is enable data for enabling the selectors 415 and 431. The D3 included in the serial data is enable data for enabling the selectors 419 and 427.

For example, in the case where only one heater Seg20 is to be selected, the values illustrated in FIG. 11 are set in the serial data. Specifically, the pieces of data included in the serial data are set as follows.
D0: Low
D1: High
D2 to 3: Low
BE0: Low
BE1: Low
BE2: High
BE3: Low

Then, in the case where the _HE goes to Low after the rising of the LS, one drive circuit 103 corresponding to the heater Seg20 is activated, and the heater Seg20 is driven.

Moreover, for example, in the case where only two heaters Seg20 and Seg 52 are to be selected, the values illustrated in FIG. 11 are set in the serial data. Specifically, the pieces of data included in the serial data are set as follows.
D0: Low
D1: High
D2: Low
D3: High
BE0: Low
BE1: Low
BE2: High
BE3: Low

Then, in the case where the _HE goes to Low after the rising of the LS, total of two drive circuits 103 corresponding to the heaters Seg20 and Seg 52 are activated, and the heaters Seg20 and Seg 52 are driven.

Moreover, for example, in the case where four heaters Seg4, Seg20, Seg36, and Seg 52 are to be selected, the values illustrated in FIG. 11 are set in the serial data. Specifically, the pieces of data included in the serial data are set as follows.
D0 to D3: High
BE0: Low
BE1: Low
BE2: High
BE3: Low

Then, in the case where the _HE goes to Low after the rising of the LS, total of four drive circuits 103 corresponding to the heaters Seg4, Seg20, Seg36, and Seg 52 are activated, and the heaters Seg4, Seg20, Seg36, and Seg 52 are driven.

Zero to four drive circuits 103 can be activated depending on the number of pieces of data set to High among the D0 to D3, and zero to four heaters can be driven in response to this activation.

In this case, the selectors 416 and 432 are enabled in the case where the D0 goes to High. The selectors 420 and 428 are enabled in the case where the D1 goes to High. The selectors 415 and 431 are enabled in the case where the D2 goes to High. The selectors 419 and 427 are enabled in the case where the D3 goes to High. Then, in the case where the set of the selectors 416 and 432 is enabled, the set of the selectors 416 and 432 selects one heater 101 designated by the BE0, the BE1, the BE2, and the BE3, and causes the drive circuit 103 corresponding to the selected heater to drive the heater. In this situation, there are the case where the selector 416 selects one heater 101 and the selector 432 selects none of the heaters 101 and the case where the selector 416 selects none of the heaters 101 and the selector 432 selects one heater 101. Similarly, in the case where the set of the selectors 420 and 428 is enabled, the set of the selectors 420 and 428 selects one heater 101 designated by the BE0, the BE1, the BE2, and the BE3, and causes the drive circuit 103 corresponding to the selected heater to drive the heater. In this situation, there are the case where the selector 420 selects one heater 101 and the selector 428 selects none of the heaters 101 and the case where the selector 420 selects none of the heaters 101 and the selector 428 selects one heater 101. Similarly, in the case where the set of the selectors 415 and 431 is enabled, the set of the selectors 415 and 431 selects one heater 101 designated by the BE0, the BE1, the BE2, and the BE3, and causes the drive circuit 103 corresponding to the selected heater to drive the heater. In this situation, there are the case where the selector 415 selects one heater 101 and the selector 431 selects none of the heaters 101 and the case where the selector 415 selects none of the heaters 101 and the selector 431 selects one heater 101. Similarly, in the case where the set of the selectors 419 and 427 is enabled, the set of the selectors 419 and 427 selects one heater 101 designated by the BE0, the BE1, the BE2, and the BE3, and causes the drive circuit 103 corresponding to the selected heater to drive the heater. In this situation, there are the case where the selector 419 selects one heater 101 and the selector 427 selects none of the heaters 101 and the case where the selector 419 selects none of the heaters 101 and the selector 427 selects one heater 101. Accordingly, in the case where the circuit illustrated in FIG. 6 is viewed as a whole, a maximum of four heaters 101 are simultaneously driven by the drive circuits 103 corresponding to the respective heaters 101. In a view limited to the first selection circuit 105, a maximum of four heaters 101 are simultaneously driven by the drive circuits 103 corresponding to the respective heaters 101. Similarly, in a view limited to the second selection circuit 106, a maximum of four heaters 101 are simultaneously driven by the drive circuits 103 corresponding to the respective heaters 101. Accordingly, the first selection circuit 105 includes as many selectors as the maximum total number of heaters 101 simultaneously selectable by the set of the first selection circuit 105 and the second selection circuit 106. Similarly, the second selection circuit 106 includes as many selectors as the maximum total number of heaters 101 simultaneously selectable by the set of the first selection circuit 105 and the second selection circuit 106.

Since the heaters arranged in one array at high density can be driven as described above, the ejection element substrate 100 can be downsized, and the liquid ejection head including the ejection element substrate 100 can be also downsized. Moreover, it is possible to reduce the DFFs, the LTs, and the decoders and further downsize the ejection element substrate 100 from those in the first and second embodiments, and the liquid ejection head including the ejection element substrate 100 can be also downsized. Furthermore, since the number of electrodes for data input can be reduced, it is possible to reduce the sealing regions for preventing invasion of the ink into the electrodes and improve reliability, as in the second embodiment.

### Fourth Embodiment

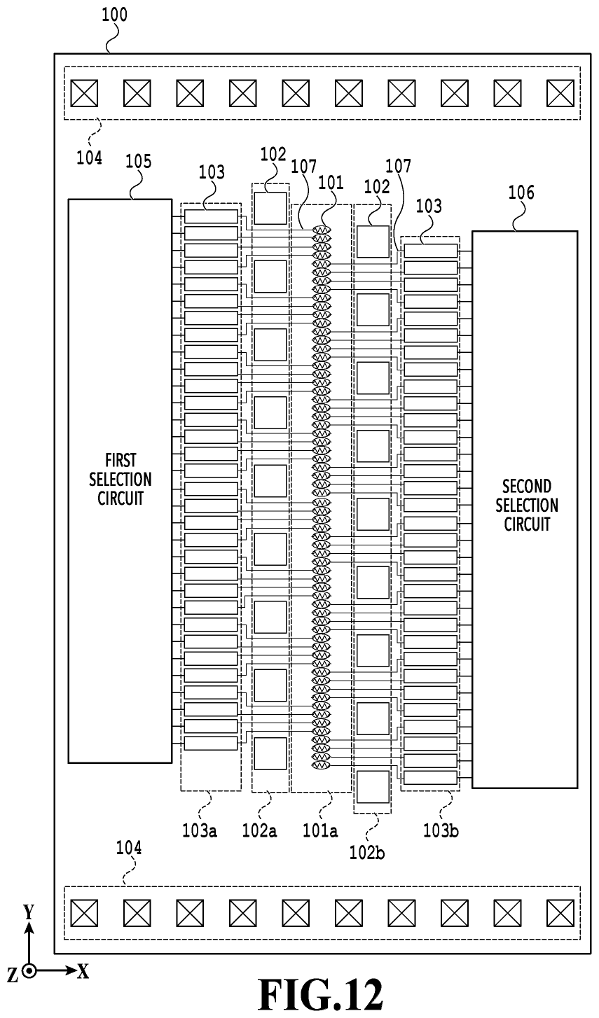

FIG. 12 is a plan diagram illustrating an entire ejection element substrate 100 according to a fourth embodiment.

The ejection element substrate according to the fourth embodiment is different from the ejection element substrate according to the first to third embodiments illustrated in FIG. 1 in at least the following two points.

A first difference is as follows. In the ejection element substrate 100 according to the first to third embodiments, as illustrated in FIG. 1, the ink supply ports 102 included in the first ink supply port array 102a and the ink supply ports 102 included in the second ink supply port array 102b are arranged in a rectangular lattice pattern of two arrays. Accordingly, each of at least some of the ink supply ports 102 included in the first ink supply port array 102a and a corresponding one of at least some of the ink supply ports 102 included in the second ink supply port array 102b are arranged at the same position in the direction (Y direction) of the heater array 101a. Meanwhile, in the ejection element substrate 100 according to the fourth embodiment, as illustrated in FIG. 12, the ink supply ports 102 included in the first ink supply port array 102a and the ink supply ports 102 included in the second ink supply port array 102b are arranged in a staggered pattern of two arrays. Accordingly, at least some of the ink supply ports 102 included in the first ink supply port array 102a and at least some of the ink supply ports 102 included in the second ink supply port array 102b are arranged alternately in the direction (Y direction) of the heater array 101a.

The other difference is as follows. In the ejection element substrate 100 of the first embodiment, as illustrated in FIG. 1, every other heater 101 among the multiple heaters 101 included in the heater array 101a are connected to the drive circuits 103 included in the first drive circuit array 103a, and the other multiple heaters 101 are connected to the drive circuits 103 included in the second drive circuit array 103b. As an example, the heaters Seg0, Seg2, . . . , Seg60, and Seg62 are connected to the drive circuits 103 included in the first drive circuit array 103a. Moreover, the heaters Seg1, Seg3, . . . , Seg61, and Seg63 are connected to the drive circuits 103 included in the second drive circuit array 103b. The same applies to the ejection element substrates 100 according to the second and third embodiments. Meanwhile, in the ejection element substrate 100 according to the fourth embodiment, the multiple heaters 101 included in the heater array 101a are connected to the drive circuits 103 as follows. Specifically, as illustrated in FIG. 12, every other set of four heaters are connected to the drive circuits 103 included in the first drive circuit array 103a, and the other sets of four heaters are connected to the drive circuits 103 included in the second drive circuit array 103b. As an example, the heaters Seg0 to Seg3, Seg8 to Seg11, . . . , and Seg56 to Seg59 are connected to the drive circuits 103 included in the first drive circuit array 103a. Moreover, the heaters Seg4 to Seg7, Seg12 to Seg15, . . . , and Seg60 to Seg63 are connected to the drive circuits 103 included in the second drive circuit array 103b. More differences are described later.

In the ejection element substrate 100 according to the first embodiment, as illustrated in FIG. 1, one of the four wiring lines 107 arranged in a region between each adjacent two of the ink supply ports 102 has a linear shape, but the other three wiring lines 107 do not have the linear shape. Two of the other three wiring lines 107 each have the following portions between the heaters 101 and the ink supply ports 102. Specifically, the two (for example, two wiring lines corresponding to the heaters Seg0 and Seg2, respectively) of the other three wiring lines each have a portion extending in a direction (X direction (also referred to as “second direction” or “sub-direction”)) orthogonal to the direction (Y direction) of the heater array 101a and a portion extending in the same direction (Y direction) as the direction (Y direction) of the heater array 101a. Accordingly, a region for arranging at least two wiring lines side by side in the X direction needs to be provided between the heater array 101a and each ink supply port array (for example, the ink supply port array 102a).

Meanwhile, in the ejection element substrate 100 according to the fourth embodiment, as illustrated in FIG. 12, all of the four wiring lines 107 arranged in the region between each adjacent two of the ink supply ports 102 have a linear shape extending in the X direction at least in a predetermined region. In this case, the predetermined region is a region obtained by connecting the region between each adjacent two of the ink supply ports 102 and a region from the region between each adjacent two of the ink supply ports 102 to positions where the heaters 101 are present. Accordingly, in the ejection element substrate 100 according to the fourth embodiment, none of the wiring lines 107 has the portion in which the wiring line extends in the direction (Y direction) of the heater array 101a, in the region between the heater array 101a and the ink supply port array 102a. Hence, there is no need to provide the region for arranging the wiring lines between the heater array 101a and the ink supply port array 102a. Thus, the ink supply port array 102a can be arranged closer to the heater array 101a. Similarly, none of the wiring lines 107 has the portion in which the wiring line extends in the direction (Y direction) of the heater array 101a, in the region between the heater array 101a and the ink supply port array 102b. Hence, there is no need to provide the region for arranging the wiring lines between the heater array 101a and the ink supply port array 102b. Thus, the ink supply port array 102b can be arranged closer to the heater array 101a. Accordingly, a time period taken to supply the ink from the ink supply ports 102 to the pressure chambers 156 and a time period taken to collect the ink from the pressure chambers 156 into the ink supply ports can be reduced. This enables high-speed printing. Moreover, since there is no need to provide the region for arranging the wiring lines in either the region between the heater array 101a and the ink supply port array 102a or the region between the heater array 101a and the ink supply port array 102b, the ejection element substrate 100 can be downsized.

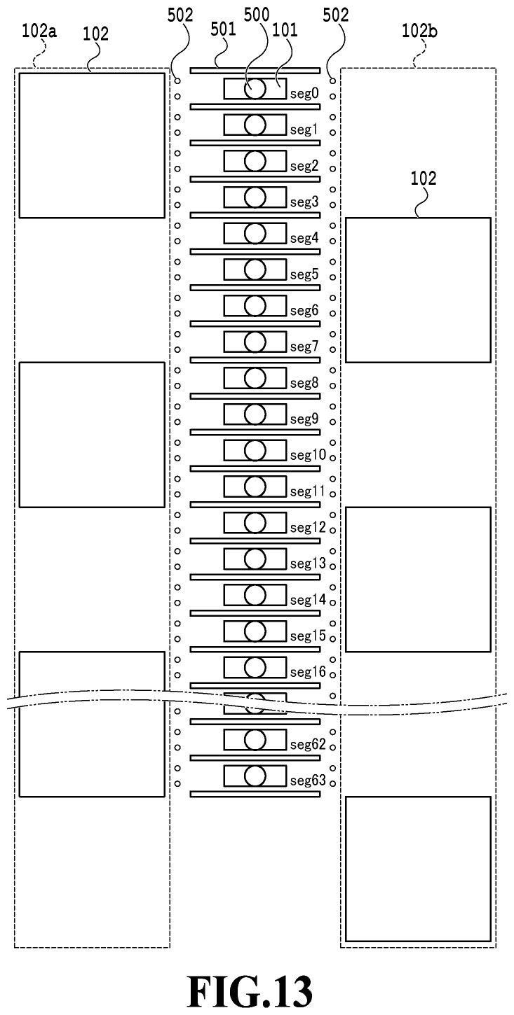

FIG. 13 is a plan diagram in which part of the ejection element substrate 100 according to the fourth embodiment is enlarged. The ejection element substrate 100 according to the fourth embodiment is different from the configuration illustrated in FIG. 2 in that the ink supply ports 102 in the ink supply port array 102a and the ink supply port array 102b are arranged in the staggered pattern.

Since the configuration of the ejection element substrate 100 according to the fourth embodiment and the configuration of the orifice plate 151 attached to this ejection element substrate 100 are basically the same as the configuration of the ejection element substrate 100 according to the first embodiment and the configuration of the orifice plate 151 attached to this ejection element substrate 100, only the differences are explained. The differences are such that, as explained with reference to FIG. 12, the multiple ink supply ports 102 belonging to the first ink supply port array 102a and the multiple ink supply ports 102 belonging to the second ink supply port array 102b are arranged in the staggered pattern of two arrays.

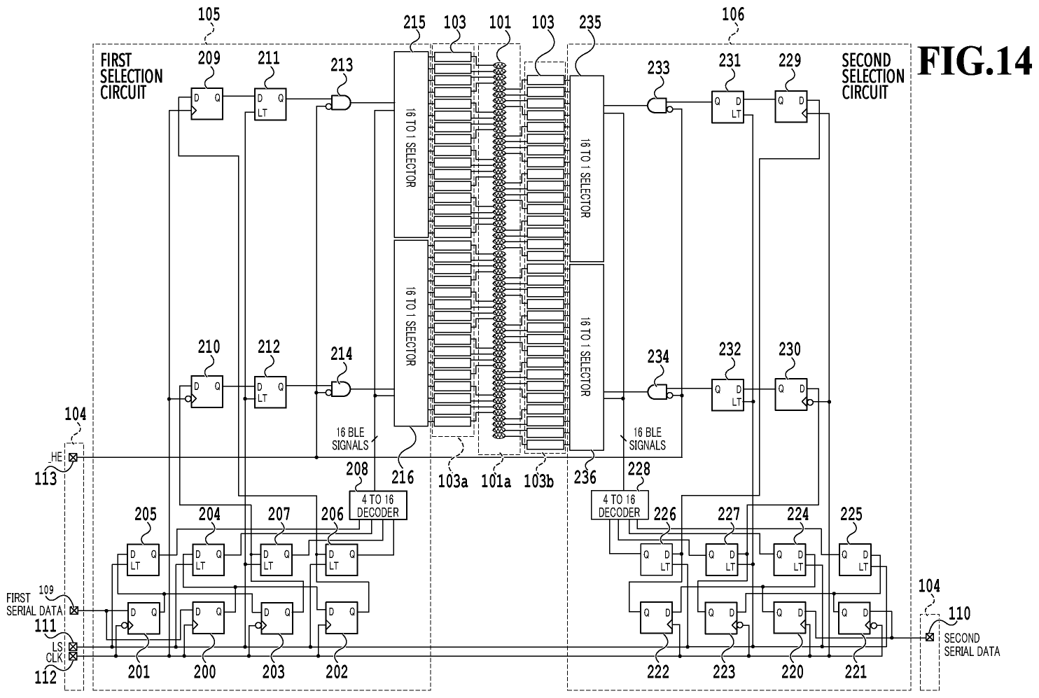

FIG. 14 is a circuit diagram illustrating circuits mounted in the ejection element substrate 100 according to the fourth embodiment. A basic configuration of the circuits mounted in the ejection element substrate 100 according to the fourth embodiment is the same as the basic configuration of the circuits mounted in the ejection element substrate 100 according to the first embodiment. The connection relationship between the drive circuits 103 and the heaters 101 in the ejection element substrate 100 according to the first embodiment is as illustrated in FIG. 1, and is also illustrated in FIG. 3. Meanwhile, a connection relationship between the drive circuits 103 and the heaters 101 in the ejection element substrate 100 according to the fourth embodiment is as illustrated in FIG. 12, and is also illustrated in FIG. 14. As apparent from FIGS. 1, 3, 12, and 14, the ejection element substrate 100 according to the fourth embodiment is different from the ejection element substrate 100 according to the first embodiment only in the connection relationship between the drive circuits 103 and the heaters 101. Accordingly, only the connection relationship between the drive circuits 103 and the heaters 101 is explained, and overlapping explanation of the common parts is omitted.

16 drive circuits 103 selectable by the selector 215 are connected to the heaters Seg0 to 3, Seg8 to 11, Seg16 to 19, and Seg24 to 27, respectively. 16 drive circuits 103 selectable by the selector 216 are connected to the heaters Seg32 to 35, Seg40 to 43, Seg48 to 51, and Seg56 to 59, respectively. 16 drive circuits 103 selectable by the selector 235 are connected to the heaters Seg4 to 7, Seg12 to 15, Seg20 to 23, and Seg28 to 31, respectively. 16 drive circuits 103 selectable by the selector 236 are connected to the heaters Seg36 to 39, Seg44 to 47, Seg52 to 55, and Seg60 to 63, respectively.

An operation of the circuits mounted in the ejection element substrate 100 according to the fourth embodiment is the same as the operation of the circuits mounted in the ejection element substrate 100 according to the first embodiment. Since this operation is already explained with reference to FIG. 4, overlapping explanation is omitted.

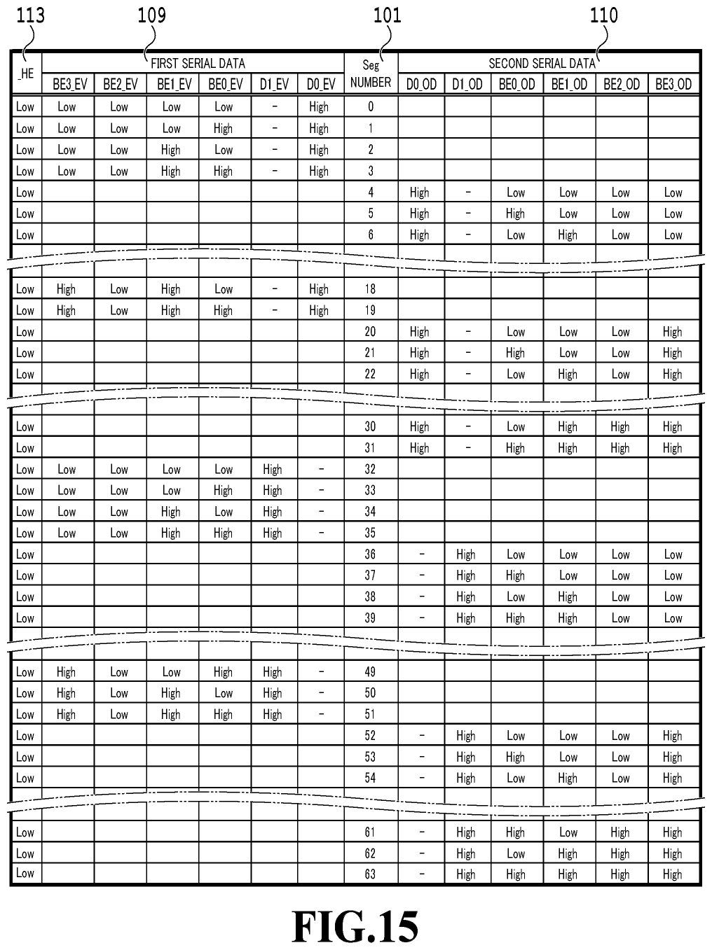

FIG. 15 illustrates a table illustrating a relationship between the selection control data inputted into the selection circuits 105 and 106 illustrated in FIG. 14 and the heaters 101 selected by these selection circuits 105 and 106. In this case, the selection control data is included in both of the first serial data and the second serial data. The BE0_EV, the BE1_EV, the BE2 EV, and the BE3_EV included in the first serial data form the first selection control data encoded in binary. The D0_EV and the D1 EV included in the first serial data are the pieces of enable data for enabling the selectors 215 and 216, respectively. The BE0_OD, the BE1_OD, the BE2_OD, and the BE3_OD included in the second serial data form the second selection control data encoded in binary. The D0_OD and the D1_OD included in the second serial data are the pieces of enable data for enabling the selectors 235 and 236, respectively.

For example, in the case where only one heater Seg20 is to be selected, the values illustrated in FIG. 15 are set in the first serial data and the second serial data. Specifically, the pieces of data included in the first serial data are set as follows.
D0 EV: Low
D1 EV: Low
BE0 to 3_EV: High or Low

Moreover, the pieces of data included in the second serial data are set as follows.
D0_OD: High
D1_OD: Low
BE0 to 2: Low
BE3_OD: High

Then, in the case where the _HE goes to Low after the rising of the LS, one drive circuit 103 corresponding to the heater Seg20 is activated, and the heater Seg20 is driven.

Moreover, for example, in the case where only two heaters Seg20 and Seg 52 are to be selected, the values illustrated in FIG. 15 are set in the first serial data and the second serial data. Specifically, the pieces of data included in the first serial data are set as follows.
D0 EV: Low
D1 EV: Low
BE0 to 3_EV: Lo or High

Moreover, the pieces of data included in the second serial data are set as follows.
D0_OD: High
D1_OD: High
BE0 to 2_OD: Low
BE3_OD: High

Then, in the case where the _HE goes to Low after the rising of the LS, total of two drive circuits 103 corresponding to the heaters Seg20 and Seg 52 are activated, and the heaters Seg20 and Seg 52 are driven.

Moreover, for example, in the case where four heaters Seg0, Seg20, Seg32, and Seg 52 are to be selected, the values illustrated in FIG. 15 are set in the first serial data and the second serial data. Specifically, the pieces of data included in the first serial data are set as follows.
D0_EV: High
D1_EV: High
BE0 to 3_EV: Low

Moreover, the pieces of data included in the second serial data are set as follows.
D0_OD: High
D1_OD: High
BE0 to 2_OD: Low
BE3_OD: High

Then, in the case where the _HE goes to Low after the rising of the LS, total of four drive circuits 103 corresponding to the heaters Seg0, Seg20, Seg32, and Seg 52 are activated, and the heaters Seg0, Seg20, Seg32, and Seg 52 are driven.

Zero to four drive circuits 103 can be activated depending on the number of pieces of data set to High among the D0_EV, the D1_EV, the D0_OD, and the D1_OD, and zero to four heaters can be driven in response to this activation.

Since the heaters arranged in one array at high density can be driven as described above as in the above-mentioned embodiments, the liquid ejection head in which the ejection element substrate 100 is downsized can be provided, and the liquid ejection head including this ejection element substrate 100 can be also downsized. Moreover, arranging the heater array and the ink supply ports closer to one another can further downsize the ejection element substrate 100, and can also achieve high-speed drive of the heaters.

### Fifth Embodiment

An ejection element substrate 100 according to a fifth embodiment has the basic configuration as illustrated in FIG. 12, like the ejection element substrate 100 according to the fourth embodiment.

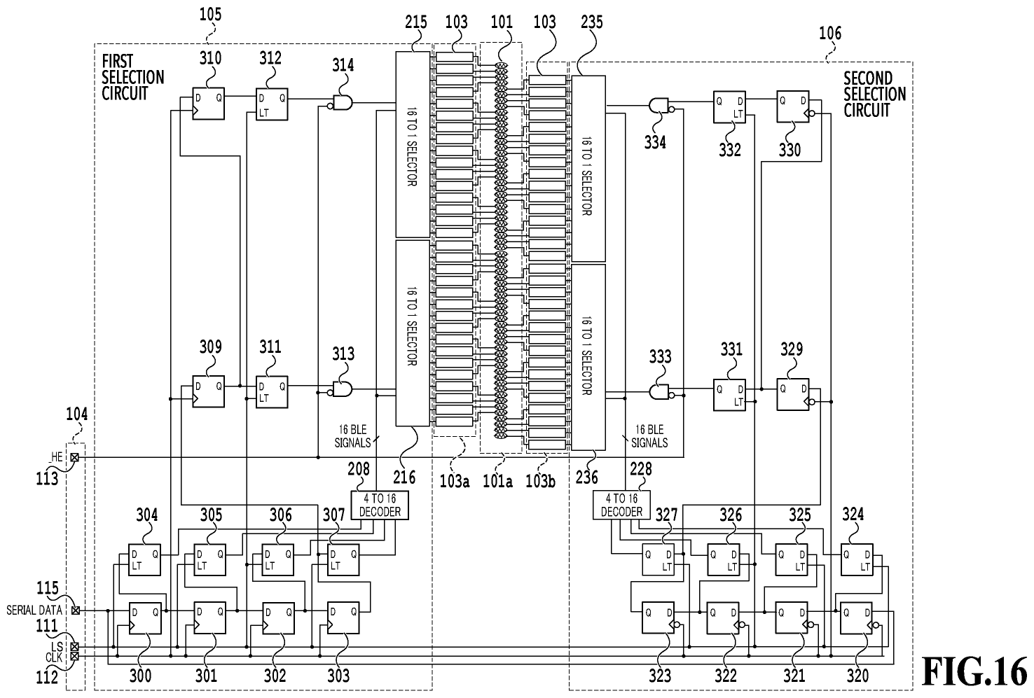

FIG. 16 is a circuit diagram illustrating circuits mounted in the ejection element substrate 100 according to the fifth embodiment. FIG. 16 particularly illustrates details of the first selection circuit 105 and the second selection circuit 106.

FIG. 16 is the circuit diagram illustrating the circuits mounted in the ejection element substrate 100 according to the fifth embodiment. A basic configuration of the circuits mounted in the ejection element substrate 100 according to the fifth embodiment is the same as the basic configuration of the circuits mounted in the ejection element substrate 100 according to the second embodiment. The connection relationship between the drive circuits 103 and the heaters 101 in the ejection element substrate 100 according to the second embodiment is as illustrated in FIG. 1, and is illustrated also in FIG. 6. Meanwhile, a connection relationship between the drive circuits 103 and the heaters 101 in the ejection element substrate 100 according to the fifth embodiment is as illustrated in FIG. 12, and is illustrated also in FIG. 16. As apparent from FIGS. 1, 6, 12, and 16, the ejection element substrate 100 according to the fifth embodiment is different from the ejection element substrate 100 according to the second embodiment only in the connection relationship between the drive circuits 103 and the heaters 101. Accordingly, only the connection relationship between the drive circuits 103 and the heaters 101 is explained, and overlapping explanation of the common parts is omitted.

16 drive circuits 103 selectable by the selector 215 are connected to the heaters Seg0 to 3, Seg8 to 11, Seg16 to 19, and Seg24 to 27, respectively. 16 drive circuits 103 selectable by the selector 216 are connected to the heaters Seg32 to 35, Seg40 to 43, Seg48 to 51, and Seg56 to 59, respectively. 16 drive circuits 103 selectable by the selector 235 are connected to the heaters Seg4 to 7, Seg12 to 15, Seg20 to 23, and Seg28 to 31, respectively. 16 drive circuits 103 selectable by the selector 236 are connected to the heaters Seg36 to 39, Seg44 to 47, Seg52 to 55, and Seg60 to 63, respectively.

An operation of the circuits mounted in the ejection element substrate 100 according to the fifth embodiment is the same as the operation of the circuits mounted in the ejection element substrate 100 according to the second embodiment. Since this operation is already explained with reference to FIG. 7, overlapping explanation is omitted.

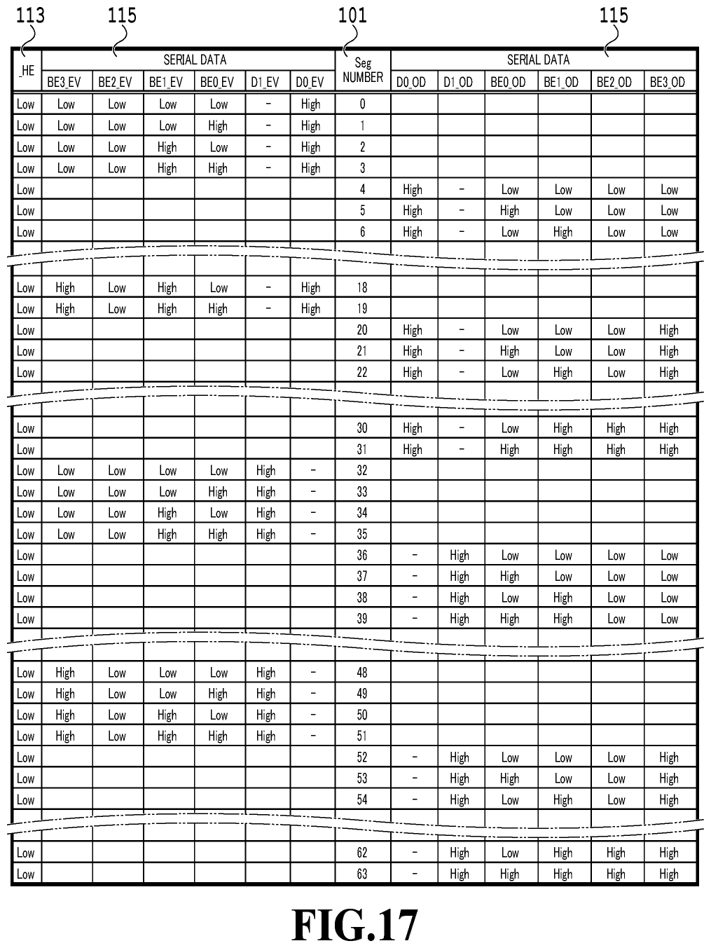

FIG. 17 illustrates a table illustrating a relationship between the selection control data inputted into the selection circuits 105 and 106 illustrated in FIG. 16 and the heaters 101 selected by these selection circuits 105 and 106. In this case, the selection control data is included in the serial data. The BE0 EV, the BE1 EV, the BE2_EV, and the BE3 EV included in the serial data form the first selection control data encoded in binary. The D0 EV and the D1 EV included in the serial data are the pieces of enable data for enabling the selectors 215 and 216, respectively. The BE0_OD, the BE1_OD, the BE2_OD, and the BE3_OD included in the serial data form the second selection control data encoded in binary. The D0_OD and the D1_OD included in the serial data are the pieces of enable data for enabling the selectors 235 and 236, respectively.

For example, in the case where only one heater Seg20 is to be selected, the values illustrated in FIG. 17 are set in the serial data. Specifically, the pieces of data included in the serial data are set as follows.
D0 EV: Low
D1 EV: Low
BE0 to 3_EV: Low or High

Moreover, the other pieces of data included in the serial data are set as follows.
D0_OD: High
D1_OD: Low
BE0 to 2_OD: Low
BE3_OD: High

Then, in the case where the _HE goes to Low after the rising of the LS, one drive circuit 103 corresponding to the heater Seg20 is activated, and the heater Seg20 is driven.

Moreover, for example, in the case where only two heaters Seg20 and Seg 52 are to be selected, the values illustrated in FIG. 17 are set in the serial data. Specifically, the pieces of data included in the serial data are set as follows.
D0 EV: Low
D1 EV: Low
BE0 to 3_EV: Low or High

Moreover, the other pieces of data included in the serial data are set as follows.
D0_OD: High
D1_OD: High
BE0 to 2_OD: Low
BE3_OD: High

Then, in the case where the _HE goes to Low after the rising of the LS, two drive circuits 103 corresponding to the heaters Seg20 and Seg 52 are activated, and the heaters Seg20 and Seg 52 are driven.

Moreover, for example, in the case where four heaters Seg0, Seg20, Seg32, and Seg 52 are to be selected, the values illustrated in FIG. 17 are set in the serial data. Specifically, the pieces of data included in the serial data are set as follows.
D0_EV: High
D1_EV: High
BE0 to 3_EV: Low

Moreover, the other pieces of data included in the serial data are set as follows.
D0_OD: High
D1_OD: High
BE0 to 2_OD: Low
BE3_OD: High

Then, in the case where the _HE goes to Low after the rising of the LS, total of four drive circuits 103 corresponding to the heaters Seg0, Seg20, Seg32, and Seg 52 are activated, and the heaters Seg0, Seg20, Seg32, and Seg 52 are driven.

Zero to four drive circuits 103 can be activated depending on the number of pieces of data set to High among the D0_EV, the D1_EV, the D0_OD, and the D1_OD, and zero to four heaters can be driven in response to this activation.

Since the heaters arranged in one array at high density can be driven as described above as in the above-mentioned embodiments, the liquid ejection head in which the ejection element substrate 100 is downsized can be provided, and the liquid ejection head including this ejection element substrate 100 can be also downsized. Moreover, since the number of electrodes for data input can be reduced, it is possible to reduce the sealing regions for preventing invasion of the ink into the electrodes and improve reliability, as in the second and third embodiments. Furthermore, arranging the heater array and the ink supply ports closer to one another can further downsize the ejection element substrate 100, and can also achieve high-speed drive of the heaters as in the fourth embodiment.

### Sixth Embodiment

The ejection element substrate 100 according to a sixth embodiment has the basic configuration as illustrated in FIG. 12, like the ejection element substrate 100 according to the fourth embodiment.

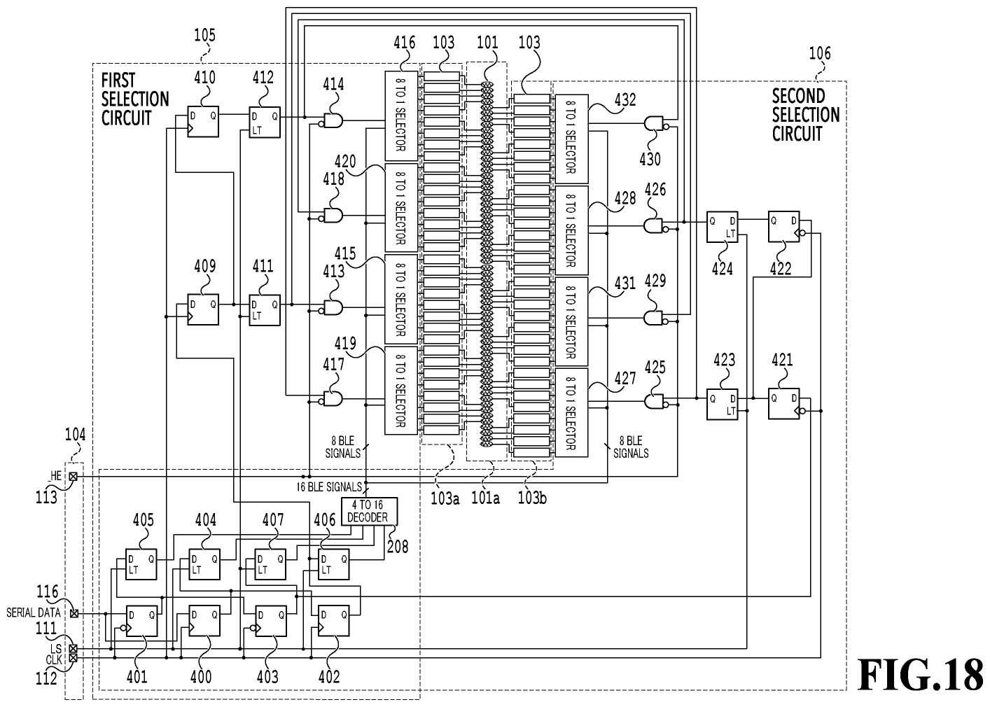

FIG. 18 is a circuit diagram illustrating circuits mounted in the ejection element substrate 100 according to the sixth embodiment. FIG. 18 particularly illustrates details of the first selection circuit 105 and the second selection circuit 106.

FIG. 18 is the circuit diagram illustrating the circuits mounted in the ejection element substrate 100 according to the sixth embodiment. A basic configuration of the circuits mounted in the ejection element substrate 100 according to the sixth embodiment is the same as the basic configuration of the circuits mounted in the ejection element substrate 100 according to the third embodiment. The connection relationship between the drive circuits 103 and the heaters 101 in the ejection element substrate 100 according to the third embodiment is as illustrated in FIG. 1, and is illustrated also in FIG. 9. Meanwhile, a connection relationship between the drive circuits 103 and the heaters 101 in the ejection element substrate 100 according to the sixth embodiment is as illustrated in FIG. 12, and is illustrated also in FIG. 18. As apparent from FIGS. 1, 9, 12, and 18, the ejection element substrate 100 according to the sixth embodiment is different from the ejection element substrate 100 according to the third embodiment only in the connection relationship between the drive circuits 103 and the heaters 101. Accordingly, only the connection relationship between the drive circuits 103 and the heaters 101 is explained, and overlapping explanation of the common parts is omitted.

Eight drive circuits 103 selectable by the selector 416 are connected to the heaters Seg0 to 3 and Seg8 to 11, respectively. Eight drive circuits 103 selectable by the selector 420 are connected to the heaters Seg16 to 19 and Seg24 to 27, respectively. Eight drive circuits 103 selectable by the selector 415 are connected to the heaters Seg32 to 35 and Seg40 to 43, respectively. Eight drive circuits 103 selectable by the selector 419 are connected to the heaters Seg48 to 51 and Seg56 to 59, respectively. Eight drive circuits 103 selectable by the selector 432 are connected to the heaters Seg4 to 7 and Seg12 to 15, respectively. Eight drive circuits 103 selectable by the selector 428 are connected to the heaters Seg20 to 23 and Seg28 to 31, respectively. Eight drive circuits 103 selectable by the selector 431 are connected to the heaters Seg36 to 39 and Seg44 to 47, respectively. Eight drive circuits 103 selectable by the selector 427 are connected to the heaters Seg52 to 55 and Seg60 to 63, respectively.

An operation of the circuits mounted in the ejection element substrate 100 according to the sixth embodiment is the same as the operation of the circuits mounted in the ejection element substrate 100 according to the third embodiment. Since this operation is already explained with reference to FIG. 10, overlapping explanation is omitted.

A relationship between the selection control data inputted into the selection circuits 105 and 106 illustrated in FIG. 18 and the heaters 101 selected by these selection circuits 105 and 106 is the same as that in the third embodiment, and is explained with reference to FIG. 11. Accordingly, overlapping explanation is omitted.

Driving the heaters arranged in one array at high density and reducing the DFFs, the LTs, and the decoders as described above can provide a liquid ejection head in which the ejection element substrate 100 is downsized.

Moreover, arranging the heater array and the ink supply ports closer to one another can further downsize the ejection element substrate 100, and can also achieve high-speed drive of the heaters.

Since the heaters arranged in one array at high density can be driven as described above as in the above-mentioned embodiments, the liquid ejection head in which the ejection element substrate 100 is downsized can be provided, and the liquid ejection head including this ejection element substrate 100 can be also downsized.

Moreover, the DFFs, the LTs, and the decoders can be reduced from those in the first, second, fourth, and fifth embodiments. The ejection element substrate 100 can be further downsized, and the liquid ejection head including this ejection element substrate 100 can be also downsized. Furthermore, since the number of electrodes for data input can be reduced as in the second, third, and fifth embodiments, it is possible to reduce the sealing regions for preventing invasion of the ink into the electrodes and improve reliability.

Moreover, arranging the heater array and the ink supply ports closer to one another as in the fourth and fifth embodiments can further downsize the ejection element substrate 100, and can also achieve high-speed drive of the heaters.

### OTHER EMBODIMENTS

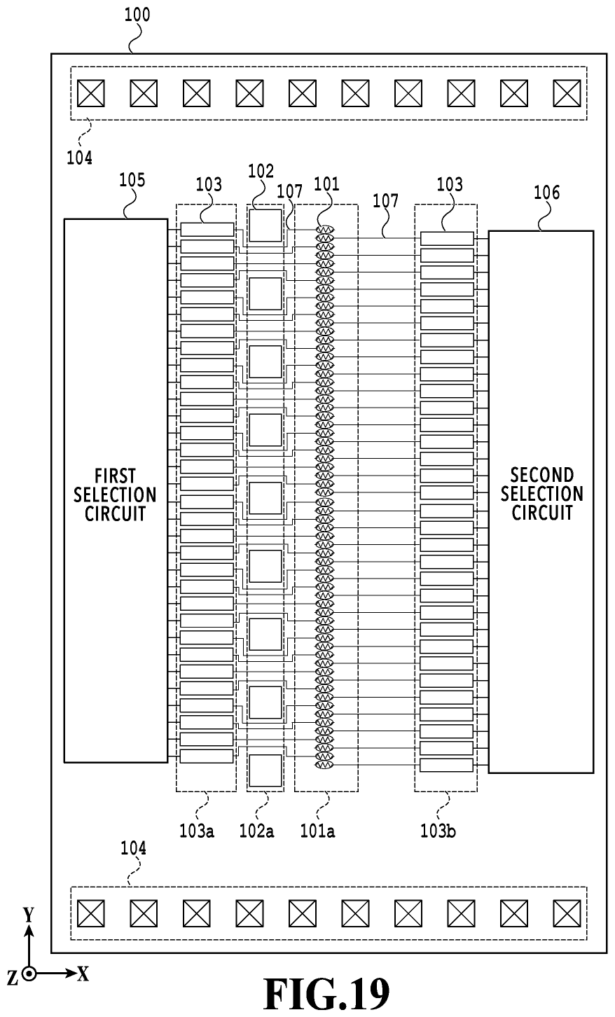

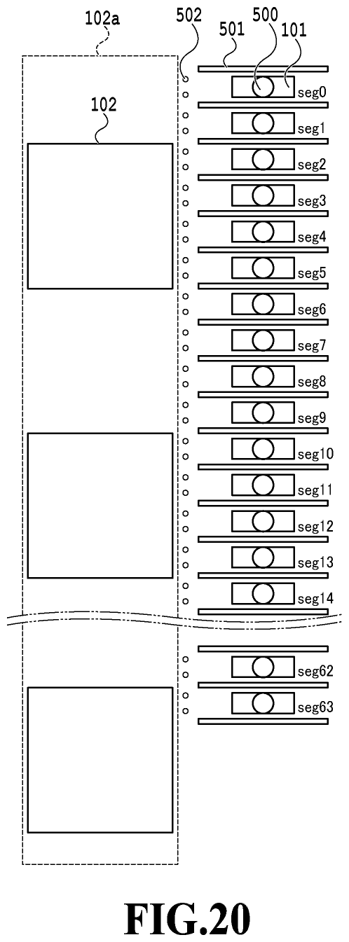

The ejection element substrates 100 according to the above-mentioned embodiments include two ink supply port arrays 102a and 102b for one heater array 101a. However, the present disclosure is not limited to this, and the ejection element substrate 100 may include only one ink supply port array 102a for one heater array 101a as illustrated in FIGS. 19 and 20.

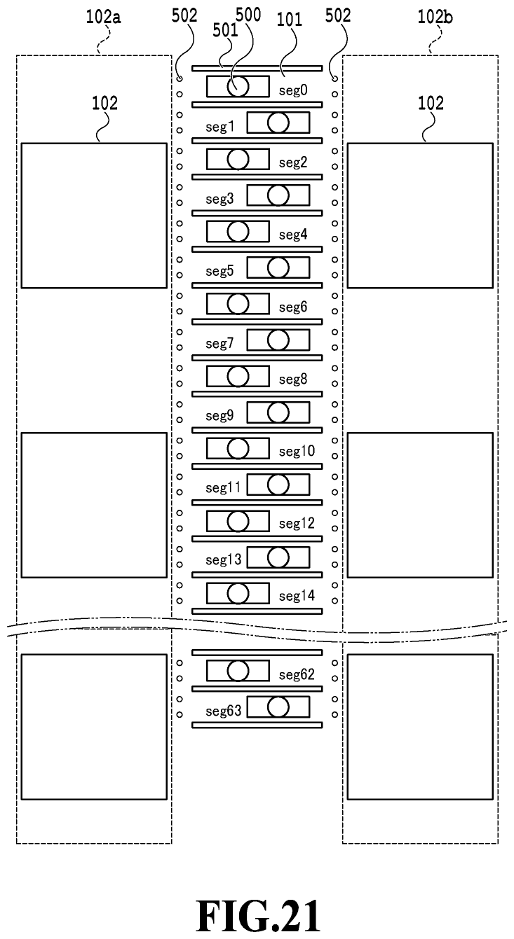

In the ejection element substrates 100 according to the above-mentioned embodiments, the multiple heaters 101 included in the heater array 101a are linearly aligned in one array having a main direction. However, the present disclosure is not limited to this, and as illustrated in FIG. 21, the multiple heaters 101 included in the heater array 101a may be aligned in a staggered pattern in two arrays having the main direction and aligned in a sub-direction orthogonal to the main direction. In this case, an interval between the two arrays forming the staggered pattern is preferably smaller than twice the pitch of the heaters 101 in the direction (Y direction) of the heater array 101a, more preferably, equal to or smaller than the pitch.

In the ejection element substrate 100 according to the above-mentioned embodiments, the arrangement intervals (pitch) of the heaters are 1,200 dpi. However, the present disclosure is not limited to this, and the arrangement intervals of the heaters may have another value.

In the ejection element substrate 100 according to the above-mentioned embodiments, the first selection circuit 105 and the second selection circuit 106 include the selectors, the ANDs, the DFFs, the LTs, and the decoders. However, the present disclosure is not limited to this, and any or all of the ANDs, the DFFs, the LTs, and the decoders may be omitted from the first selection circuit 105 and the second selection circuit 106. In this case, the omitted circuits may be provided inside or outside the ejection element substrate 100 as circuits separate from the first selection circuit 105 and the second selection circuit 106.

In the ejection element substrate 100 according to the above-mentioned embodiments, the heaters to be selected by the first selection circuit 105 and the heaters to be selected by the second selection circuit 106 are arranged alternately, or the set of four heaters to be selected by the first selection circuit 105 and the set of four heaters to be selected by the second selection circuit 106 are arranged alternately. However, the present disclosure is not limited to this, and a set of any other integer number of heaters to be selected by the first selection circuit 105 and a set of the integer number of heaters to be selected by the second selection circuit 106 may be alternately arranged, the integer number being one or more. For example, a set of two or eight heaters to be selected by the first selection circuit 105 and a set of two or eight heaters to be selected by the second selection circuit 106 may be arranged alternately.

The ejection element substrate 100 according to the above-mentioned embodiments only have one system of the circuit as illustrated in FIG. 1, 12, or 19. However, the present disclosure is not limited to this, and the ejection element substrate 100 may have multiple systems of the circuit as illustrated in FIG. 1, 12, or 19.

The present disclosure includes the following configuration.

### [Configuration 1]

An ejection element substrate comprising:
a plurality of first energy generation elements;
a plurality of first drive circuits configured to drive the plurality of first energy generation elements, respectively;
a first selection circuit configured to select some of the first drive circuits from the plurality of first drive circuits and causes the selected first drive circuits to drive some of the first energy generation elements corresponding to the selected the first drive circuits, respectively;
a plurality of second energy generation elements;
a plurality of second drive circuits configured to drive the plurality of second energy generation elements, respectively; and
a second selection circuit configured to select some of the second drive circuits from the plurality of second drive circuits and cause the selected second drive circuits to drive some of the second energy generation elements corresponding to the selected second drive circuits, respectively, wherein the plurality of first drive circuits are arranged side by side in a first direction, and the plurality of second drive circuits are arranged side by side in a first direction, and the plurality of first energy generation elements and the plurality of second energy generation elements are arranged side by side in a region between a region where the plurality of first drive circuits are arranged and a region where the plurality of second drive circuits are arranged such that the first direction is a main direction.

### [Configuration 2]

The ejection element substrate according to configuration 1, wherein
the second selection circuit includes as many second selectors as a maximum total number of the second energy generation elements simultaneously selectable by the second selection circuit, and each of the second selectors is controlled by third control data for selecting the second selectors to be enabled and fourth control data for designating the second energy generation elements to be selected by the enabled second selectors.

### [Configuration 3]

The ejection element substrate according to configuration 2, further comprising a second conversion circuit configured to parallelize the third control data and the fourth control data included in series data inputted to the ejection element substrate.

### [Configuration 4]

The ejection element substrate according to configuration 2 or 3, wherein
the fourth control data is encoded in binary, and
the ejection element substrate further comprises a second decoder configured to expand the fourth control data encoded in binary to data individually designating the second energy generation elements to be selected by the enabled second selectors.

### [Configuration 5]

The ejection element substrate according to configuration 1, wherein
the first selection circuit includes as many third selectors as a maximum total number of the first energy generation elements simultaneously selectable by the first selection circuit,
the second selection circuit includes as many fourth selectors as a maximum total number of the second energy generation elements simultaneously selectable by the second selection circuit,
each of the third selectors is controlled by fifth control data for selecting the third selectors to be enabled and sixth control data for designating the first energy generation elements to be selected by the enabled third selectors,
each of the fourth selectors is controlled by seventh control data for selecting the fourth selectors to be enabled and eighth control data for designating the second energy generation elements to be selected by the enabled fourth selectors, and
the ejection element substrate further comprises:
   a third conversion circuit configured to parallelize the fifth control data and the sixth control data included in series data inputted to the ejection element substrate; and
   a fourth conversion circuit configured to parallelize the seventh control data and the eighth control data included in the series data.

### [Configuration 6]

The ejection element substrate according to configuration 5, wherein
the sixth control data is encoded in binary, and
the ejection element substrate further comprises a third decoder configured to expand the sixth control data encoded in binary to data individually designating the first energy generation elements to be selected by the enabled third selectors.

### [Configuration 7]

The ejection element substrate according to configuration 5 or 6, wherein
the eighth control data is encoded in binary, and
the ejection element substrate further comprises a fourth decoder configured to expand the eighth control data encoded in binary to data individually designating the second energy generation elements to be selected by the enabled fourth selectors.

### [Configuration 8]

The ejection element substrate according to configuration 1, wherein
a set of the first selection circuit and the second selection circuit is capable of selecting at least one of the first energy generation elements, at least one of the second energy generation elements, or both of the at least one of the first energy generation elements and the at least one of the second energy generation elements,
the first selection circuit further includes as many fifth selectors as a maximum total number of the first energy generation elements and the second energy generation elements simultaneously selectable by the set of the first selection circuit and the second selection circuit,
the second selection circuit further includes as many sixth selectors as a maximum total number, and
each of the fifth selectors and the sixth selectors are controlled by ninth control data for selecting a set of the fifth selectors and the sixth selectors to be enabled and tenth control data for designating the first energy generation elements or the second energy generation elements to be selected by the set of the enabled fifth selectors and the enabled sixth selectors.

### [Configuration 9]

The ejection element substrate according to configuration 8, further comprising a fifth conversion circuit configured to parallelize the ninth control data and the tenth control data included in series data inputted to the ejection element substrate.

### [Configuration 10]

The ejection element substrate according to configuration 8 or 9, wherein
the tenth control data is encoded in binary, and the ejection element substrate further comprises a fifth decoder configured to expand the tenth control data encoded in binary to data individually designating the first energy generation elements or the second energy generation elements to be selected by the set of the enabled fifth selectors and the enabled sixth selectors.

According to the present disclosure, the area of the ejection element substrate can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-032205, filed Mar. 4, 2024, which is hereby incorporated by reference wherein in its entirety.

What is claimed is:

1. An ejection element substrate comprising:
a plurality of first energy generation elements;
a plurality of first drive circuits configured to drive the plurality of first energy generation elements, respectively;
a first selection circuit configured to select some of the first drive circuits from the plurality of first drive circuits and cause the selected first drive circuits to drive some of the first energy generation elements corresponding to the selected first drive circuits, respectively;
a plurality of second energy generation elements;
a plurality of second drive circuits configured to drive the plurality of second energy generation elements, respectively; and
a second selection circuit configured to select some of the second drive circuits from the plurality of second drive circuits and cause the selected second drive circuits to drive some of the second energy generation elements corresponding to the selected second drive circuits, respectively, wherein
the plurality of first drive circuits are arranged side by side in a first direction and the plurality of second drive circuits are arranged side by side along the first direction, and
the plurality of first energy generation elements and the plurality of second energy generation elements are arranged side by side in a region between a region where the plurality of first drive circuits are arranged and a region where the plurality of second drive circuits are arranged such that a set of an integer number of the first energy generation elements and a set of the integer number of the second energy generation elements are arranged alternately with the first direction being a main direction, the integer number being one or more.

2. The ejection element substrate according to claim 1, wherein the plurality of first energy generation elements and the plurality of second energy generation elements are arranged to be linearly aligned in one array having the first direction.

3. The ejection element substrate according to claim 1, wherein the plurality of first energy generation elements and the plurality of second energy generation elements are arranged to be aligned in a staggered pattern of two arrays having the first direction.

4. The ejection element substrate according to claim 1, wherein the first selection circuit is arranged in a region that is on a side on which the region where the plurality of first drive circuits are arranged is present, with respect to the region where the plurality of first energy generation elements and the plurality of second energy generation elements are arranged side by side, and that is farther away from the region where the plurality of first energy generation elements and the plurality of second energy generation elements are arranged side by side than the region where the plurality of first drive circuits are arranged.

5. The ejection element substrate according to claim 1, wherein the second selection circuit is arranged in a region that is on a side on which the region where the plurality of second drive circuits are arranged is present, with respect to the region where the plurality of first energy generation elements and the plurality of second energy generation elements are arranged side by side, and that is farther away from the region where the plurality of first energy generation elements and the plurality of second energy generation elements are arranged side by side than the region where the plurality of second drive circuits are arranged.

6. The ejection element substrate according to claim 1, wherein
a plurality of first ink supply ports are opened side by side in a region between the region where the plurality of first energy generation elements and the plurality of second energy generation elements are arranged side by side and the region where the plurality of first drive circuits are arranged, and
a plurality of second ink supply ports are opened side by side in a region between the region where the plurality of first energy generation elements and the plurality of second energy generation elements are arranged side by side and the region where the plurality of second drive circuits are arranged.

7. The ejection element substrate according to claim 6, wherein
the plurality of first energy generation elements and the plurality of second energy generation elements are arranged side by side linearly in one array having the first direction, or arranged side by side in a staggered pattern of two arrays having the first direction, and
each of at least some of the first ink supply ports included in the plurality of first ink supply ports and at least some of the second ink supply ports included in the plurality of second ink supply ports are arranged at the same position in the first direction.

8. The ejection element substrate according to claim 6, wherein
the plurality of first energy generation elements and the plurality of second energy generation elements are arranged side by side linearly in one array having the first direction, or arranged side by side in a staggered pattern of two arrays having the first direction, and
at least some of the first ink supply ports included in the plurality of first ink supply ports and at least some of the second ink supply ports included in the plurality of second ink supply ports are arranged alternately in the first direction.

9. The ejection element substrate according to claim 8, wherein wiring lines that connect the first energy generation elements and the first drive circuits to one another and that are partially arranged in a region between each adjacent two of the first ink supply ports extend linearly in a second direction orthogonal to the first direction, in the region between each adjacent two of the first ink supply ports and a region between the first energy generation elements and the region between each adjacent two of the first ink supply ports.

10. The ejection element substrate according to claim 8, wherein wiring lines that connect the second energy generation elements and the second drive circuits to one another and that are partially arranged in a region between each adjacent two of the second ink supply ports extend linearly in a second direction orthogonal to the first direction, in the region between each adjacent two of the second ink supply ports and a region between the second energy generation elements and the region between each adjacent two of the second ink supply ports.

11. The ejection element substrate according to claim 1, wherein a plurality of third ink supply ports are opened side by side in a region between the region where the plurality of first energy generation elements and the plurality of second energy generation elements are arranged side by side and the region where the plurality of first drive circuits are arranged.

12. The ejection element substrate according to claim 1, wherein
the plurality of first drive circuits are arranged side by side at a first pitch in the first direction,
the plurality of second drive circuits are arranged side by side at the first pitch in the first direction,
the plurality of first energy generation elements and the plurality of second energy generation elements are arranged side by side at a second pitch in the first direction, and
the first pitch is twice the second pitch.

13. The ejection element substrate according to claim 1, wherein
the some of the first energy generation elements selected by the first selection circuit is one or more of the first energy generation elements, and
the some of the second energy generation elements selected by the second selection circuit is one or more of the second energy generation elements.

14. The ejection element substrate according to claim 1, wherein
the first selection circuit includes as many first selectors as a maximum total number of the first energy generation elements simultaneously selectable by the first selection circuit, and
each of the first selectors is controlled by first control data for selecting the first selectors to be enabled and second control data for designating the first energy generation elements to be selected by the enabled first selectors.

15. The ejection element substrate according to claim 14, further comprising a first conversion circuit configured to parallelize the first control data and the second control data included in series data inputted to the ejection element substrate.

16. The ejection element substrate according to claim 14, wherein
the second control data is encoded in binary, and
the ejection element substrate further comprises a first decoder configured to expand the second control data encoded in binary to data individually designating the first energy generation elements to be selected by the enabled first selectors.

17. The ejection element substrate according to claim 1, wherein
the second selection circuit includes as many second selectors as a maximum total number of the second energy generation elements simultaneously selectable by the second selection circuit, and
each of the second selectors is controlled by third control data for selecting the second selectors to be enabled and fourth control data for designating the second energy generation elements to be selected by the enabled second selectors.

18. The ejection element substrate according to claim 1, wherein
the first selection circuit includes as many third selectors as a maximum total number of the first energy generation elements simultaneously selectable by the first selection circuit,
the second selection circuit includes as many fourth selectors as a maximum total number of the second energy generation elements simultaneously selectable by the second selection circuit,
each of the third selectors is controlled by fifth control data for selecting the third selectors to be enabled and sixth control data for designating the first energy generation elements to be selected by the enabled third selectors,
each of the fourth selectors is controlled by seventh control data for selecting the fourth selectors to be enabled and eighth control data for designating the second energy generation elements to be selected by the enabled fourth selectors, and
the ejection element substrate further comprises:
a third conversion circuit configured to parallelize the fifth control data and the sixth control data included in series data inputted to the ejection element substrate; and
a fourth conversion circuit configured to parallelize the seventh control data and the eighth control data included in the series data.

19. The ejection element substrate according to claim 1, wherein
a set of the first selection circuit and the second selection circuit is capable of selecting at least one of the first energy generation elements, at least one of the second energy generation elements, or both of the at least one of the first energy generation elements and the at least one of the second energy generation elements,
the first selection circuit further includes as many fifth selectors as a maximum total number of the first energy generation elements and the second energy generation elements simultaneously selectable by the set of the first selection circuit and the second selection circuit,
the second selection circuit further includes as many sixth selectors as the maximum total number, and
each of the fifth selectors and the sixth selectors is controlled by ninth control data for selecting a set of the fifth selectors and the sixth selectors to be enabled and tenth control data for designating the first energy generation elements or the second energy generation elements to be selected by the set of the enabled fifth selectors and the enabled sixth selectors.

20. A liquid ejection head comprising:
an ejection element substrate; and
an orifice plate attached to the ejection element substrate, wherein
the ejection element substrate includes:
a plurality of first energy generation elements;
a plurality of first drive circuits configured to drive the plurality of first energy generation elements, respectively;
a first selection circuit configured to select some of the first drive circuits from the plurality of first drive circuits and cause the selected first drive circuits to drive some of the first energy generation elements corresponding to the selected the first drive circuits, respectively;
a plurality of second energy generation elements;
a plurality of second drive circuits configured to drive the plurality of second energy generation elements, respectively; and
a second selection circuit configured to select some of the second drive circuits from the plurality of second drive circuits and cause the selected second drive circuits to drive some of the second energy generation elements corresponding to the selected second drive circuits, respectively,
the plurality of first drive circuits are arranged side by side along a first direction, and the plurality of second drive circuits are arranged side by side along the first direction,
the plurality of first energy generation elements and the plurality of second energy generation elements are arranged side by side in a region between a region where the plurality of first drive circuits are arranged and a region where the plurality of second drive circuits are arranged such that the first direction is a main direction,
a boundary portion between the ejection element substrate and the orifice plate is provided with
a first common flow path communicating with a plurality of first ink supply ports,
a second common flow path communicating with a plurality of second ink supply ports,
a plurality of first individual flow paths communicating with the first common flow path,
a plurality of second individual flow paths communicating with the second common flow path, and
a plurality of pressure chambers communicating with the plurality of first individual flow paths, respectively, and with the plurality of second individual flow paths, respectively,
the orifice plate includes a plurality of ejection ports that allow the plurality of pressure chambers to communicate with an outside, and
the energy generation elements are arranged at positions where the energy generation elements face the ejection ports of the pressure chambers, respectively.
